(19) United States
(12) Patent Application Publication
(10) Pub. No.: US 2005/0140678 A1
(43) Pub. Date: Jun. 30, 2005

(54) Computer graphics systems and methods

(76) Inventors: Johan Gielis, Antwerp (BE); Edwin Bastiaena, Antwerpen (BE); Bert Belrinckx, Antwerpen (BE)

Correspondence Address: ROTHWELL, FIGG, ERNST & MANBECK, P.C., 1425 K STREET, N.W., SUITE 800, WASHINGTON, DC, 20005, US

(21) Appl. No.: 10/870,683

(22) Filed: Jun. 18, 2004

Related U.S. Application Data
(63) Continuation-in-part of application No. 09/566,986, filed on May 9, 2000.
(60) Provisional application No. 60/479,177, filed on Jun. 18, 2003.
(60) Provisional application No. 60/133,279, filed on May 10, 1999.

(51) Int. Cl. G06T 11/20

(52) U.S. Cl. 345/441

(57) ABSTRACT

In some preferred embodiments, a new kind of graphical editor is provided. Preferably, the graphical editor utilizes the SUPERFORMULA™ formula. In some preferred embodiments, a graphical editor can be used to, e.g., create 2-D images, 3-D images and/or animations.

The present application claims priority to provisional application Ser. No. 60/479,177 entitled Computer Graphics Systems and Methods, filed on Jun. 18, 2003, to Johan Gielis, et al., and is a continuation-in-part of U.S. patent application Ser. No. 09/566,986 to Johan Gielis, entitled Patterns Utilizing Novel “SUPERFORMULA” Operator, filed on May 9, 2000, which claims priority to provisional application Ser. No. 60/133,279 to Johan Gielis, entitled “Method and Apparatus for Synthesizing And Analysing Patterns . . . ,” filed on May 10, 1999, and to PCT Publication Number WO 00/68888 to Johan Gielis, published on Nov. 16, 2000 entitled “Method and Apparatus for Synthesizing Patterns.” The entire disclosures of each-and-every one of the above-listed four applications are incorporated herein by reference in their entireties.

### BACKGROUND

1. Field of the Invention

The preferred embodiments of the present invention relate to computer graphics, such as, e.g., the synthesis of forms and patterns using, for example, a graphical editor.

2. Introduction

Computer graphics systems have existed since the introduction of the computer and have since been used widely in diverse fields such as, e.g., computer aided design (CAD), computer aided manufacture (CAM), soft modeling, animations (such as, e.g., cartoons), Internet and Web Site graphics, scientific visualization, and more. The introduction of techniques based on polynomials (such as, e.g., Beziers, Splines, NURBS, etc.) has also substantially enhanced the potential of visualization.

Computer graphics have been applied in 2-D applications and 3-D applications. Moreover, computer graphics have been applied in a variety of contexts, from the formation of single images to the creation of animations (such as, e.g., time series displays of images).

With existing systems, there are essentially two forms of—generally opposite—technologies or methodologies that are employed. At one end, a methodology involving the selection of images from a database of primitives has been employed. Such databases are usually very limited in ability to select images (e.g., a user may merely be able to select only between, e.g., a rectangle or an ellipse in 2-D or a sphere, cube or cone in 3-D). At the other end, drawing programs can provide “freeform” drawing capabilities—such as, e.g., based on Bezier (e.g., 2-D) and/or NURBS (e.g., 3-D). Typically, these freeform drawing tools are not easily controlled, even though some efforts have been made seeking try to make such freeform drawing more manageable and controllable.

There are a substantial number of problems with existing systems and methods. There is a need to overcome a variety of problems which exists in the art, such as, e.g., enhancing usability and/or user-friendliness, reducing computer memory and/or data storage usage (e.g., reducing data-file sizes), enhancing the user's ability and/or creativity (e.g., enabling intuitive drawing or the like).

There, thus, remains a need for new systems and methods overcoming problems noted herein-above and/or other problems.

3. Introduction to the SUPERFORMULA

The SUPERFORMULA developed by the present inventors and detailed in the above-noted priority applications, incorporated herein by reference, can be advantageously applied in, inter alia, unique computer applications for, for example, the synthesis and analysis of patterns.

First, the equation for a circle in Cartesian coordinates is presented.
x²+y²=R² (1)

Second, the equation is generalized as follows.
~x^{ñ}+y^{ñ}=Rⁿ (2)

Third, the equation is transformed into polar coordinates (with x=r cos φ; and y=r sin φ) as follows.
|rⁿ cosⁿ φ|+|rⁿ sinⁿ φ|=Rⁿ (3)

Fourth, the equation is modified as follows.

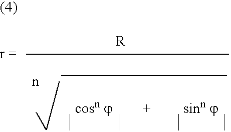

Fifth, the equation is modified to introduce rotational symmetries: introducing m φ.

Sixth, the equation is modified to introduce differentiation in the exponent n: introducing n₁, n₂ and/or n₃.

Seventh, the equation is modified to introduce differences in axis length: introducing A and/or B.

The “SUPERFORMULA” can then be represented as follows:

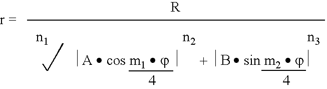

In some embodiments, can be represented in other ways. For example, the SUPERFORMULA can be represented as starting from the equation of an ellipse such that the formula has 1/a and 1/b instead of A and B and such that the nominator becomes 1. This manner of representing the SUPERFORMULA is preferred since the SUPERFORMULA is preferably to be usable as a linear operator proper as described herein. Thus, the SUPERFORMULA is thus preferably represented as follows:

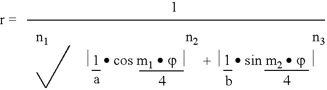

In addition to the above two methods of representation, the SUPERFORMULA can be mathematically represented in a variety of ways. The mode of representation can be selected in accordance with the particular application at hand. Exemplary, but not limiting, modes of representation include the following:
(a) The SUPERFORMULA as shown above (which can be represented by the operator symbol, noted in the above-noted patent applications incorporated herein by reference and below as a short hand representation).
(b) The graph of the SUPERFORMULA in polar coordinates.
(c) The graph of the SUPERFORMULA in XY coordinates (e.g., with y values corresponding to the radius values r at a particular angle φ and with x values corresponding to the values of the angle φ).
(d) The XY representation of the projection of the polygon created by the SUPERFORMULA onto a certain system of axes (e.g., cos φ/□ⱼ in the orthogonal system).
(e) The polar representation of that in (d) above.

In addition, the SUPERFORMULA may also be represented in different numbers of dimensions, such as in three or more dimensions, such as, e.g., described in the above-noted applications incorporated herein-by reference in their entireties.

The various representations of the SUPERFORMULA can be utilized, for example, in both the “synthesis” and “analysis” of patterns (i.e., including for example image patterns and waveforms such as electromagnetic (e.g., electricity, light, etc.), sound and other waveforms or signal patterns) and the like.

In order to synthesize various patterns, the parameters in this equation can be modified so that a variety of patterns can be synthesized. Notably, the parameters m₁, m₂, n₁, n₂, n₃, a and/or b can be moderated. By moderating or modulating the number of rotational symmetries (mᵢ), exponents (nᵢ), and/or short and long axes (a and b), a wide variety of natural, human-made and abstract shapes can be created. The moderation of these parameters can also be carried out in a well-defined and logical manner. In this manner, and as described further below, in some representations of the SUPERFORMULA one or more of the parameters can be functions, such that the SUPERFORMULA generalizes into virtually an any shape algorithm. The formula can be used to generate a large class of super-shapes and sub-shapes. In view of the advancement of the above formula beyond existing super-circles and sub-circles (Lame-ovals), this new formula is coined herein as the “SUPERFORMULA.”

While the equation can define various shapes, any point within the contour of the shape can be defined as well, for 0<R<Rₘₐₓ if a=b, for 0<a,b<aₘₐₓ and bₘₐₓ.

This new SUPERFORMULA can be used advantageously as a novel linear operator. When combined with other functions, the formula proper can also transform or moderate such functions. When the function f(φ)=constant, the formula is like that shown above. In combination with other functions it will moderate, for example, the graphs of these functions—e.g., to become more flattened, to become more pointed, or to have a different number of rotational symmetries, etc. For ease in reference, the present novel linear operator (i.e., the SUPERFORMULA), with its unique moderation abilities, is identified herein by the following new symbol.
1/□ⱼ
Where: r·□=1

In addition to the foregoing, the SUPERFORMULA can, as discussed in detail below, be similarly applied in three or more dimensions and in a variety of representations and applications.

### SUMMARY OF SOME PREFERRED EMBODIMENTS

The preferred embodiments of the present invention can significantly improve upon existing systems and methods.

In some embodiments, the present invention can overcome the above and/or other problems experienced in the arts above. In some preferred embodiments, a new kind of graphical editor is provided. Preferably, the graphical editor utilizes the SUPERFORMULA™ (such as, e.g., described in the above-referenced applications, herein and/or in attachments hereto). In some preferred embodiments, a graphical editor can be used to, e.g., create 2-D images, 3-D images and/or animations.

The preferred embodiments can be employed in, e.g., any appropriate field(s) in which computer graphics are or may be used. The various embodiments can provide a universal technology that can, e.g., be employed in any and all currently known and/or later developed platforms.

Some preferred embodiments can be used to provide a simple and powerful way to help close the above-mentioned gap between primitives and freeform graphics. For example, some embodiments enable the providing (e.g., in substantially real time) of a much greater diversity of primitives, which can at the same time be modified by freeform deformation (e.g., based on the SUPERFORMULA). In preferred embodiments, a graphical editor can be employed that is very user friendly, has a high controllability, and/or facilitates the manageability of shapes.

Some embodiments can be employed in computer vision, robotics and/or artificial intelligence and/or the like. For instance, some embodiments could use similar 3-D images as computer graphics embodiments, but can relate, e.g., to vision, robotics and/or the like. With respect to artificial intelligence, in some embodiments, two sections (for example) and four measurements (for example) can be sufficient to define or reconstruct a shape. In this regard, if, for example, two perpendicular sections (e.g., cross-sections) are taken, two SUPERSHAPES™ of which, e.g., a SUPERSPHERICAL product can be composed and a value m can easily be defined. In some embodiments, because of the invariants in SUPERSHAPES, only two measurements (such as, e.g., one at 0° and one at Π/m) are used to fully reconstruct the two 2-D SUPERSHAPES. In some applications, like botanical and biological models, this can be used to help describe and get a better understanding of shapes and phenomena in nature.

Various embodiments of the invention can provide one or more of a number of unique advantages over existing systems and/or methods. Some advantages that can be achieved with some graphics software embodiments include, e.g.: 1) increasing technological potential; 2) enhancing user friendliness; 3) economizing on computer calculating power; 4) enabling a great savings in memory and/or the like.

1. Increasing Technology Potential:

In various embodiments of the invention, great technical advances can be achieved.

In some illustrative embodiments, in 2-D graphics environments, one or more, or all, of the parameters can be functions. In these instances, the functions may vary for Π(phi). The functions can include any functions, such as, any mathematical equations, trigonometric functions, logarithmic functions, and/or much more. In some embodiments, functions can be used for one or more of the exponents (e.g., n values), m, a, b, etc. In this regard, functions can be used in any of the SUPERFORMULA parameters described in the above-mentioned patent applications, described herein and/or described in any of the attachments hereto. In some embodiments, this may be referred to as “c-point” technology. It is a most general expression. It is more general, e.g., than Zhou and Khambamettu (see reference on page 42), who used functions only in the exponent in superellipses. While the preferred embodiments described herein pertain to graphics editors and the like, any of the embodiments described in the above-referenced patent applications can employ one or more, or all, of the parameters as functions.

In some other embodiments, in 3-D graphics environments, a generalization of the superspherical products, as a combination of two 2-D shapes, with a further generalization of extension along a z-axis (helices and spirals in 3-D) and/or non-intersecting knots in 3-D can also provide notable advantages.

2. Enhanced User Friendliness:

In some preferred embodiments, although some underlying principles involve advances in mathematics, users of graphics software will preferably not need to understand the formula and/or the mathematical principles related thereto. The preferred embodiments enable a user to create and/or edit shapes based on the formula in simple, user friendly ways, such as for example in some embodiments, by one or more of the following:
In 2-D: creating sensitive zones;
In 2-D: using c-point (NB: this terminology is explained within this disclosure and may also be referred to as cross-point) technology;
In 2-D: using simple addition and/or subtraction;
In 2-D: providing a great number of primitives to choose from;
In 2-D: providing a simple means to select primitives;
In 3-D: using a simple interface with two 2-D shapes, one of which is the main shape, while the other is used, e.g., as a trajectory;
In 3-D: in two dimension windows, one or more of the above 2-D user interfaces and/or advantages can be used; and/or
In 3-D: by defining Boolean operations applied with the correct functions (i.e., since the shapes are defined by formula's it is easy and precise to determine which points are on, in and/or outside the shape, such that the computer does not need to determine this on triangulated surfaces).

In addition:
For 2-D and/or 3-D, the preferred embodiments can provide a simplified means to create shapes (i.e., simplifying the requirements by enabling many shapes to be created with a like procedure—i.e., one procedure for all these shapes can suffice [i.e., there is no need for substantial libraries and/or data storage and there is no need for multiple and/or different procedures]).
In graphics, there is a tension between primitives on the one hand (i.e., the choices are rather limited and libraries are needed) and free-form-deformation on the other hand (i.e., while providing real-time manipulation, these are usually limited and difficult to use). On the other hand, preferred embodiments of the invention can avoid this tension in a number of ways. On the one hand, in some embodiments, a user can with just a few “clicks” be presented with a range of primitives (e.g., which can be orders of magnitude more than current systems) and on the other hand with, e.g., crosspoint technology that provides additional freedom and/or freeform at the user's disposal. Moreover, by varying parameter values, a user can create new SUPERSHAPES according to their desires and/or needs.

In an illustrative example, a user can, e.g., choose one of, e.g., five primitives. Then, the user can use one of these primitives (e.g., paste it into his document and/or the like) or the user can “click” further to generate (e.g., in real time) a large number of other shapes which are generally close to or modifications of the original selected shape. By way of example, if the user selects (e.g., “clicks”) a pentagon, the user may be presented with a new pallet of primitives that show, e.g., a pentagon, a starfish, a five-pointed-star and/or many other shapes closely allied thereto (by way of example, in some embodiments, shapes on a pallet might, for example, include like m values, but range in one or more of the n values). In some embodiments, by further “clicking” on the starfish, the user can be presented with many more shapes that are more akin to the starfish (e.g., with different numbers of arms [such as, e.g., 5 or 6 arms], with more pointed arms, and/or with more rounded arms).

In most preferred embodiments, along with such primitive selector mechanisms, a number of defined filters and/or modifiers can also preferably be used. For example, when the user chooses a particular shape, he can preferably modify it using “sensitive zones” and/or using “free-form” or “c-point” technology.

3. Economizing on Computer Calculating Power:

In some preferred embodiments, computer calculating power can be greatly economized. Moreover, in some specific instances involving symmetry computer calculating power can be very greatly economized. For example, for symmetrical shapes such as, e.g., squares, pentagons, etc., the only calculations that need to be made are calculations around a portion of the shape (such as, e.g., from 0° to π/m). These values will suffice to determine the complete symmetrical shape. For example, instead of 3600 calculations for one full rotation of 360° (i.e., one calculation every 0.10), 3600/2 m will suffice. For example, for a ten-angle SUPERSHAPE, only the values from 0° to 18° have to be determined. From 18° to 36,° it is a mirror image, and for the rest, the same values can be used to draw the full shape. In some embodiments, these values can be stored in memory (e.g., which can involve temporary storage) and called by a graphical module for drawing.

4. Great Savings in Memory (Extremely Compact Files)

With the preferred embodiments of the invention, a great many shapes are described by only one unifying formula. As a result, this allows for a highly compact representation of models in, e.g., 2D and/or 3D. For example, as discussed below, each of the shapes shown in FIGS. 35(A) and 35(B) were encoded in far less than 4000 bytes.

In that regard, as described further below in this document, a 3D shape creator has been developed by the present assignee, called SUPERGRAPHX, in which, inter alia, a 3D artist or designer can explore a universe of mathematical objects defined by SUPERFORMULA equations (see, e.g., shapes shown in FIGS.). Using such a shape generator, very complex shapes can be constructed. However, all of these complex shapes are derived from one equation and, in preferred embodiments, differ in less than at most 20 bytes. Therefore, with preferred embodiments of the invention, it is possible to fully encode complex shapes in extremely small files.

In some applications, the 3D shape explorer can be integrated into other applications, such as, e.g., in a modeller with full parts-assembly structure with definition of Boolean structure. FIGS. 35(A)-35(B) show illustrative gear and vehicle objects that have been constructed with such a 3D shape modeller with a full object-part-assembly structure as is common in CAD/CAM. In those figures, the CAD/CAM modeller with shape, positional, parts-assembly and Boolean information for the gear (FIG. 35(A)) required only about 195 bytes and for the race car required only about 0.9 kilobytes (FIG. 35(B)).

Notably, the race car shown in FIG. 35(B) contains only 19 objects and was encoded fully in less than 900 bytes. In comparison, a shortcut from desktop to a file is typically between 400 and 800 bytes, and an icon on a desktop is usually more than about 1 kilobyte. In the preferred embodiments, based on the SUPERFORMULA a file format can be provided, referred to as GENICAP file format, provides a compact way of communication and that, as discussed below, is preferably platform independent. For example, in preferred embodiments, products developed for CINAMA4D and MAYA, by way of example, allow for reading and writing shapes in GENICAP File format with extremely small file sizes.

In preferred embodiments, for the file format, complex models can be represented in a simple way. In preferred embodiments, for each object, all data can be structure in a simple database (such as, for example, in EXCEL structure, such as, shown in FIG. 35(C). In that regard, FIG. 35(C) includes all of the data for a “pencil” for illustrative purposes. This data includes data representing the pencil having a particular pencil-like cross-section for the body, an eraser, a lead point, along with information regarding shape (e,g., Booleans), positioning, orientation and coloring information of the objects in this file.

Thus, it is demonstrated that in preferred embodiments, very small file sizes can be achieved. For instance, in ASCII, this illustrative pencil is coded in merely 838 bytes. In binary, such an illustrative pencil may be coded in (it is estimated) in about 187 bytes (NB: in the assignee's own modeller, it is less than 150 bytes). In some preferred embodiments, for every 2D and/or 3D object, a similar file structure can be used, with parameters of the SUPERFORMULA arranged in columns. In addition, parametric information (such as, e.g. if the body needs to be longer, if all other objects need to be repositioned, if a “pencil” is triangular instead of circular, if all parts have to change, and/or the like) can be easily encoded by relational information in the cells. Thus, in some preferred embodiments, as described below, performing of various functions, such as, e.g., morphing, moulding, combinations, etc., could be easily performed based on only relational data.

In preferred embodiments, the achievement of extremely small file sizes with a simple, transparent file format allows communication at all levels in, e.g., a production scheme—e.g., from the initial design with a customer to the whole design, engineering and manufacturing department. In preferred embodiments, the small files are very precise, reducing the risk of loss of information and can be used and communicated through all platforms, almost irrespective of communication channels, whether via, e.g., wired and/or wireless communications.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The accompanying figures are shown by way of example, and not limitation, in which:

FIGS. 1-19 show features, aspects and/or displayed images according to some illustrative embodiments of the present invention.

FIGS. 20-21 show an illustrative graphical user interface (GUI) that can be presented to a user in some illustrative 3D shape creator software applications.

FIGS. 22-27 show illustrates displayed images according to some illustrative embodiments, created by way of example, using a graphical user interface (GUI) similar to that shown in FIGS. 20-21.

FIGS. 28-30 show some illustrative graphical user interface (GUI) pallet windows that can be employed in some illustrative embodiments of the invention.

FIG. 31 shows an illustrative computer system that can be used to implement computerized process steps in some embodiments of the invention.

FIG. 32 is a schematic diagram depicting an illustrative common file format schema according to some embodiments of the invention.

FIG. 33 is a schematic diagram depicting a system and method for inputting images for image analyses and/or other processes.

FIG. 34(A) depicts both a distance function (upper) and supertrigonometric function (based on a triangle) shown (i.e., using the same formula, but with a different graphical expression), and FIG. 34(B) shows a windowed trigonometric function, which is also fully encoded in only the SUPERFORMULA.

FIGS. 35(A)-(B) show illustrative graphical images that can be created in some embodiments and FIG. 35(C) shows an illustrative file structure in some embodiments.

FIG. 36 shows a plurality of illustrative shapes that can be created for explanatory purposes.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

Illustrative Computer Environments:

In some illustrative embodiments, some of the process steps described herein can be performed using one or more computer(s) and/or one or more network of computer(s), such as a local area network (LAN), a wide area network (WAN), the Internet and/or another network. In various embodiments, one or more server(s), client computer(s), application computer(s) and/or other computer(s) can be utilized to implement one or more aspect of the invention. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc.

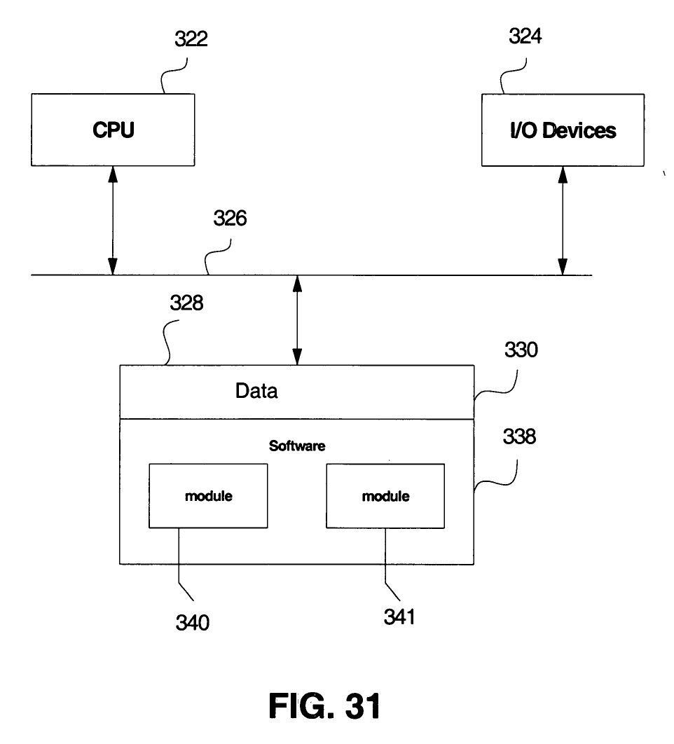

FIG. 31 shows an illustrative computer 320 that can be used to implement computerized process steps in some embodiments of the invention. In some embodiments, the computer 320 includes a central processing unit (CPU) 322, which can communicate with a set of input/output (I/O) device(s) 324 over a bus 326. The I/O devices 324 can include, for example, a keyboard, a mouse, a video monitor, a printer, and/or other devices.

The CPU 322 can communicate with a computer readable medium (e.g., conventional volatile or non-volatile data storage devices) 328 (hereafter “memory 328”) over the bus 326. The interaction between a CPU 322, I/O devices 324, a bus 326, and a memory 328 can be like that known in the art. Memory 328 can include, in some examples, SUPERSHAPE data and/or other data 330. The software 338 can include a number of modules 340 for implementing the steps of processes. Conventional programming techniques may be used to implement these modules. Memory 328 can also store the above and/or other data file(s).

In some embodiments, the various methods described herein may be implemented via a computer program product for use with a computer system. This implementation may, for example, include a series of computer instructions fixed on a computer readable medium (e.g., a diskette, a CD-ROM, ROM or the like) or transmittable to a computer system via and interface device, such as a modem or the like. The medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology. While various processes can be performed using computer software programs, one or more of the process steps could be carried out using hardware, firmware and/or software, depending on circumstances.

### The Preferred Embodiments

In some illustrative and non-limiting embodiments, a graphical editor is provided. The graphical editor can preferably be, e.g., implemented via software that is programmed into a computer. A computer can include any appropriate computer as known in the art, such as, e.g., any computer described in the above-referenced applications incorporated herein by reference. In some embodiments, a graphical editor can be provided as a plug-in to existing software. For instance, in some illustrative applications, products can be developed that include, e.g., plug-ins and/or ad ons for 2_D graphic arts software such as for example ADOBE ILLUSTRATOR software, for 3D graphic arts software such as MAYA and CINEMA4D, for architectural software such as AUTOCAD software, for general purpose software such as MICROSOFT OFFICE software and/or for various other graphics and/or engineering programs.

In some embodiments, graphical images can be displayed on a computer monitor, such as, e.g., an liquid crystal display, a television monitor, a CRT and/or any other now or later known display. In some embodiments, images can be displayed on a display of a wireless device, such as, e.g., a cellular telephone, a personal digital assistant (PDA) with wireless communications for Internet access and/or the like.

### Illustrative 2-D Embodiments

In some preferred embodiments for two dimensional computer graphics, the SUPERFORMULA can be used to provide a new and powerful way to create drawings and/or graphics. A graphical editor can be made that enables a user to draw and edit SUPERSHAPES, deform these shapes in a highly controllable way, and/or to make compositions using different SUPERSHAPES. Some illustrative applications are described below which enable the drawing and/or manipulation of SUPERSHAPES in 2-D graphics.

A. Drawing SUPERSHAPES:

In some illustrative embodiments, a graphical user interface can be created that enables a user to “click” on an “display” (such as, e.g., a monitor) with a “pointer” (such as, e.g., a mouse) somewhere inside the displayed shape and “drag” it. In some preferred embodiments, a “starting shape” can be set to appear on the display. Preferably, the starting shape can be selected by a user and/or can be set by default (such as, e.g., as a circle, ellipse and/or other shape). In some preferred embodiments, the graphical editor can be configured to depict color properties for the particular displayed shape. In some embodiments, the displayed shape will be displayed within a “window” or “frame” or the like. Preferably, this window or frame can be “moved” to a new position on the display. For example, a user might be able to move a displayed window, by way of example, to a bottom right of the user's screen, while, later, another window can appear at, e.g., a left-hand side of the screen. In preferred embodiments, a plurality of shapes can be drawn.

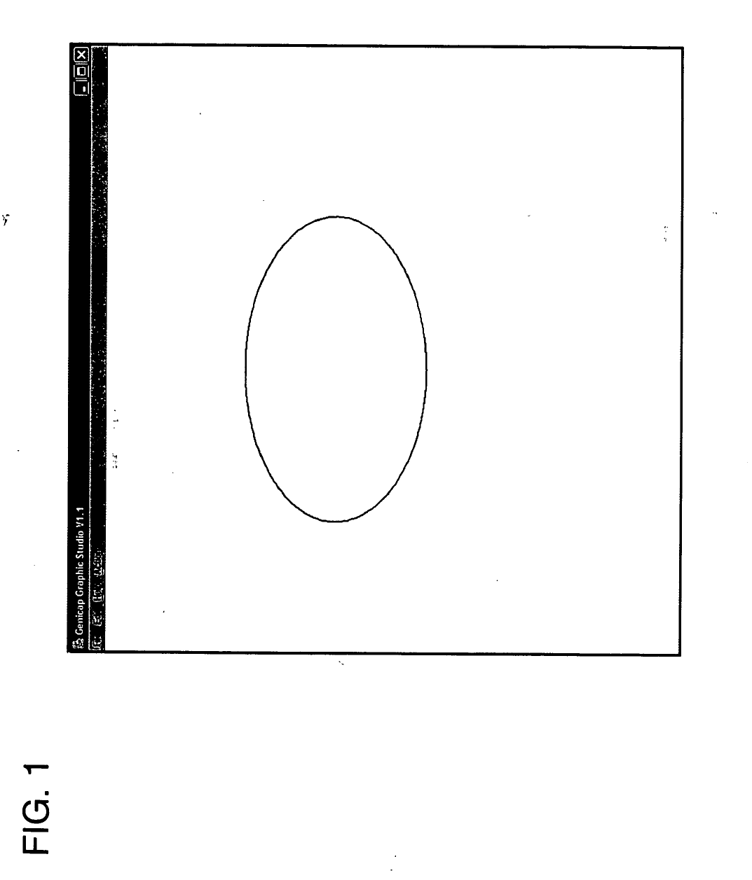

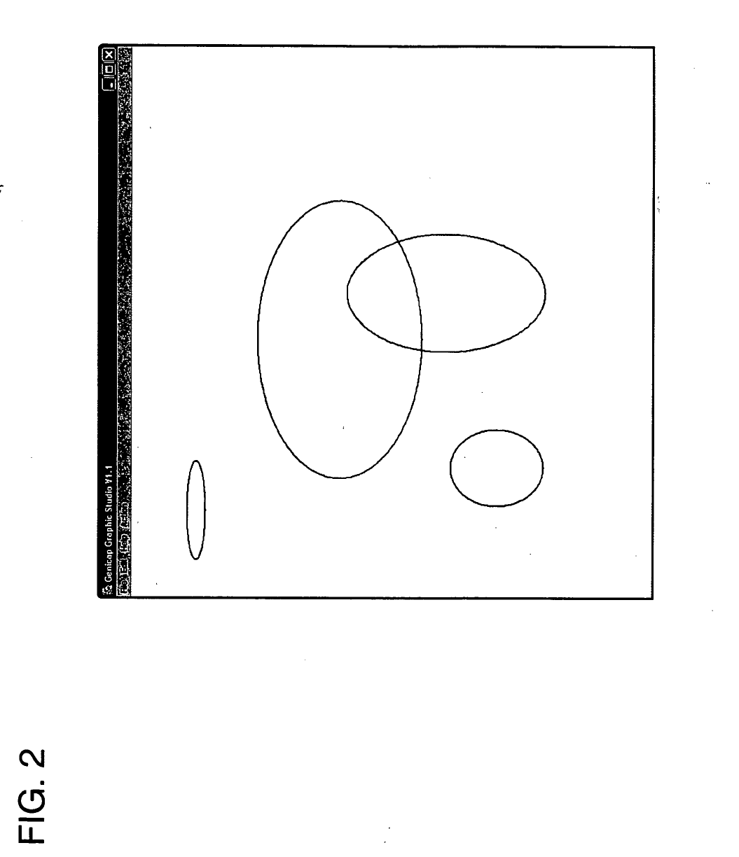

FIG. 1 shows, by way of example, a first created shape displayed on a screen or monitor or the like. On the other hand, FIG. 2, shows, by way of example, a plurality of created shapes displayed concurrently on a screen or monitor or the like.

Preferably, the user can change the shapes of the contours in different ways:
by mouse or pointer action (such as, e.g., by clicking and dragging as noted above);
by changing numbers or values of parameters in a graphical user interface (GUI), a numerical editor and/or by keyboard entry; and/or
by various Boolean operations and/or moulding methods, such as, e.g., “Adding” and/or “Cutting-Out” other shapes.
   B. Changing SUPERSHAPES (E.G., using Sensitive Zones):

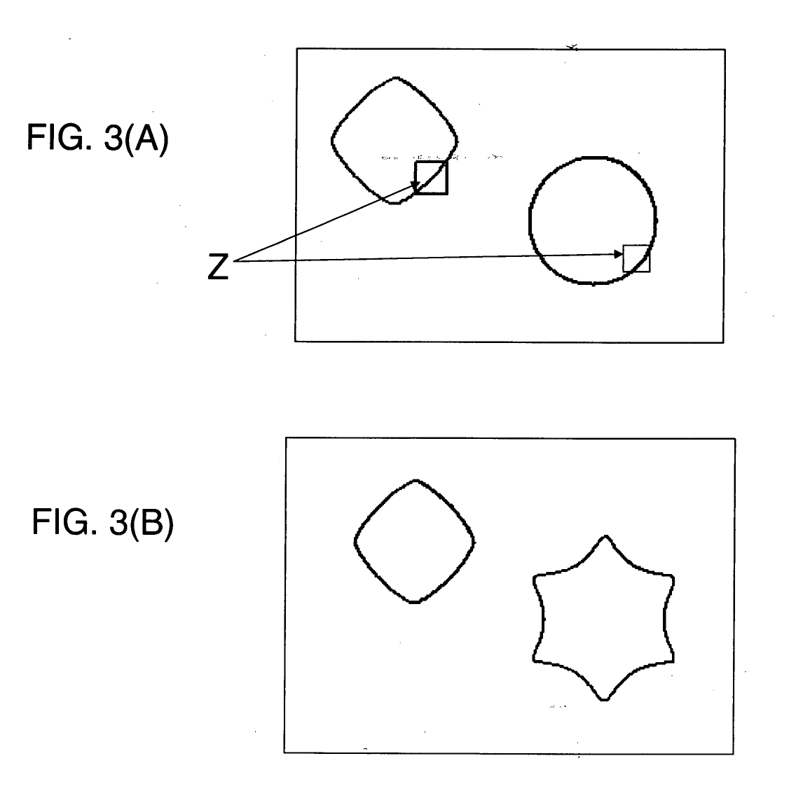

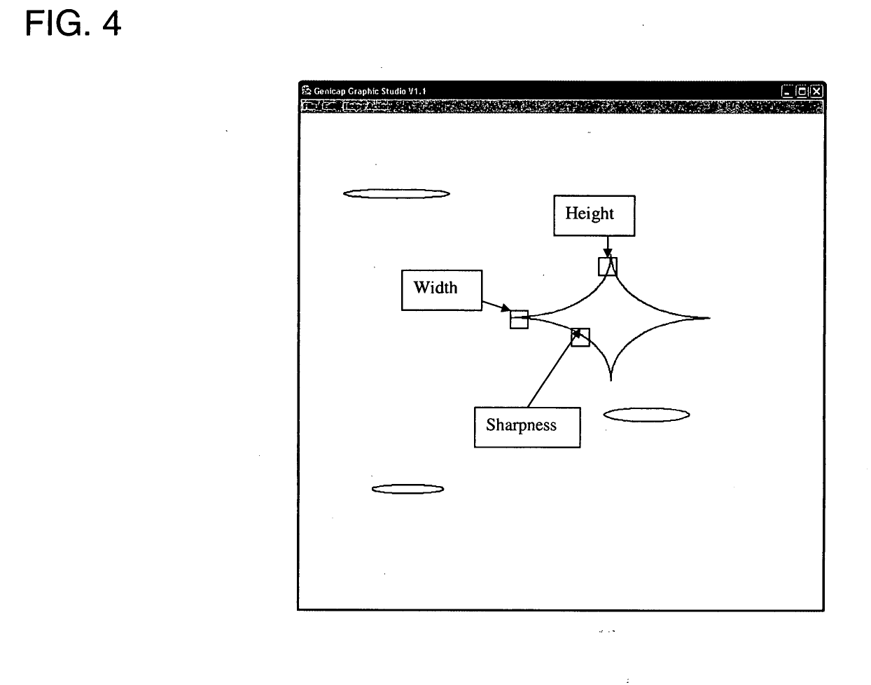

While SUPERFORMULA parameters can easily be changed using a numerical editor (which can, e.g., include arrow keys and/or gliders to facilitate manipulation of numbers or values) to input the values of the parameters, in some embodiments, one user friendly approach involves the use of “sensitive zones.” With reference to FIGS. 3(A)-3(B), for example, a sensitive zone (such as, e.g., a zone in region Z in FIG. 3(A)) can facilitate easy transformation. For example, FIG. 3(A) depicts the transformation between a circle and a rounded-square. On the other hand, FIG. 3(B), depicts a transformation of a round square into, e.g., a concave hexagon with rounded corners by using another sensitive zone. FIG. 4 shows illustrative regions that may be “clicked” to modify aspects of height, width and/or sharpness in some embodiments. In some embodiments, by merely, e.g., identifying a sensitive zone (such as, e.g., left clicking on a sensitive zone with a mouse) and identifying a movement or position change (such as, e.g., moving the mouse to a new position and releasing the left click button), a new SUPERSHAPE can be automatically generated taking into account the new positioning of the portion within the sensitive zone.

C. Changing Parameters using GUI and Parameter Values:

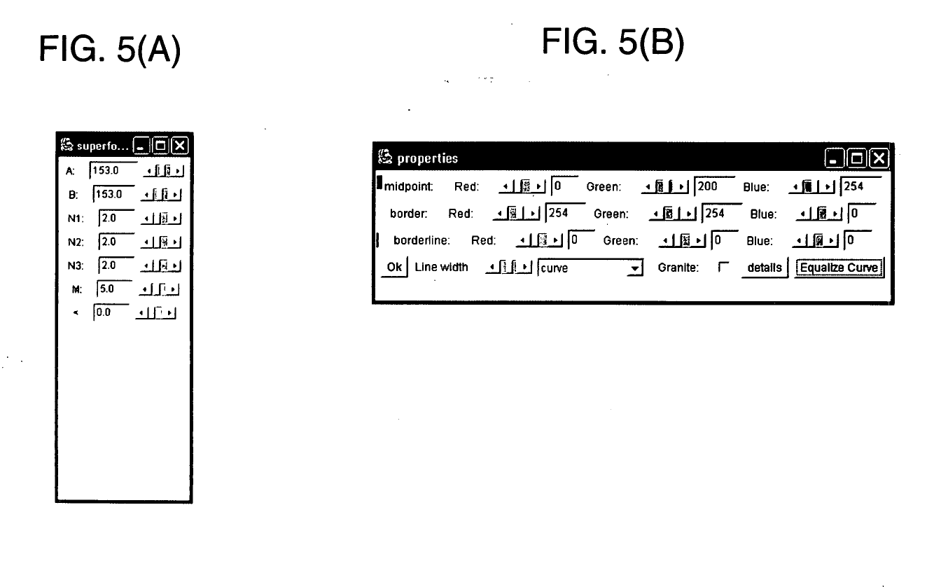

FIG. 5(A) depicts an illustrative GUI that can be provided to facilitate changing of parameter values in some embodiments. In this illustrative embodiment, the values a, b, n1, n2, n3 and/or m can be selected as desired by entry of numbers into the number boxes shown and/or by clicking the arrow keys to increase and/or decrease values. In some embodiments, users can select all values at the onset and/or the system can insert numbers upon display of a SUPERSHAPE and/or upon the default display of a SUPERSHAPE or the like.

FIG. 5(B) shows an illustrative GUI that can be used to provide enhancements to the displayed shapes, such as, e.g., color schemes and/or the like. For example, color scheme selection can include in some illustrative embodiments, selection of a midpoint color of a shape (see, e.g., midpoint), selection of a border color (e.g., an interior region adjacent the border), selection of a borderline color and/or the like. Here, numerical color values can be utilized to facilitate selection (and similar number boxes and/or arrow keys can be provided to facilitate selection). Other image modifiers can include, e.g., line width (e.g., of borderline of displayed shape), such as, e.g., shown at “Line width” with arrow key selection (shown) and/or other means of selection. Other image modifiers can include, e.g., coloring, shading or other fill-quality selection(s)(such as, e.g., granite and/or the like). Other image modifiers can include, e.g., an equalizing feature to “equalize” or smooth some or all of the shape displayed, roughening functions to make the outline rough, and/or various other image modifying functions. In addition, a “details” function can also preferably be provided which can be “clicked” to display particular details of an image or shape.

D. Adding and/or Moulding Shapes:

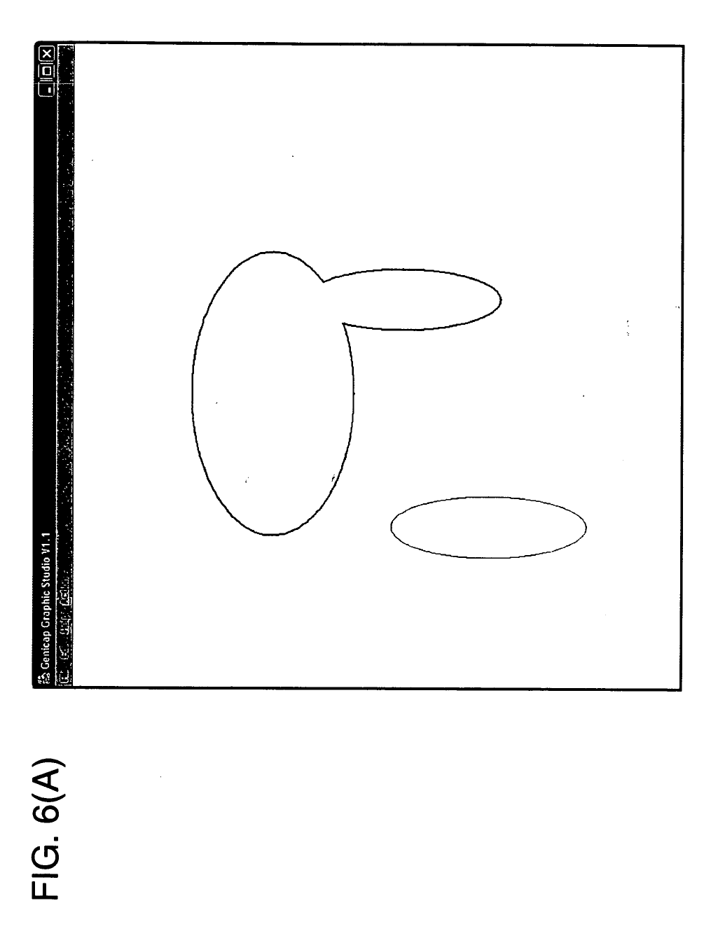

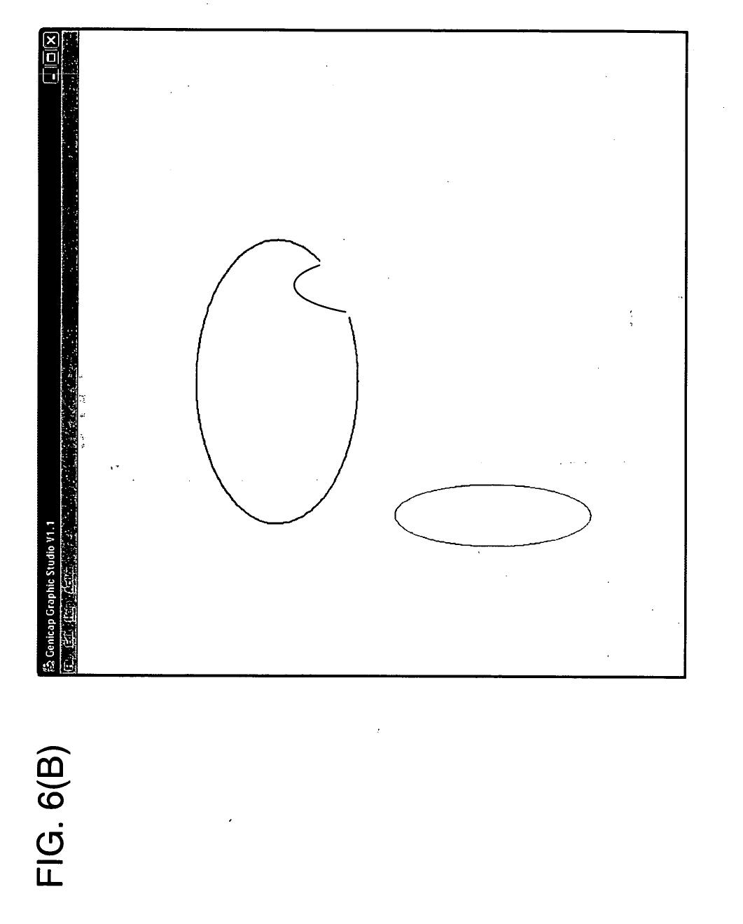

As shown in FIG. 6, in some embodiments, a graphical editor can enable the adding of different shapes together. In some examples, if two shapes P and Q are initially present, one can potential use shape Q, for example, to alter shape P. In some embodiments, one could “activate” shape Q (such as, e.g., by “clicking” on the shape Q). Preferably, an activated shape is visually discernable, such as, e.g., being a different color (e.g., blue or the like), being flickered or the like. Then, the shape is preferably set to act as a mould. In an illustrative embodiment, it can be set as a mould by pressing CTRL and clicking right mouse button (RMB). Then, in this illustrative and non-limiting example, the shape will turn another visibly discernable condition (such as, e.g., turning green). Preferably, the CTRL button can be released and, in this mode, the green shape will be a shape that the user can use to modify the shape P (e.g., adding to it). In this manner, the shape Q can be used to create a “mould” that can be manipulated via a pointer (such as, e.g., a mouse pointer).

Preferably, the mould shape can be “dragged” by the mouse pointer or the like and the user can, thus, position the mould shape. When the mould of shape Q touches the shape P, the shapes are modified, e.g., so as to add together and form a new, e.g., integral shape. FIG. 6 shows an illustrative modified shape formed by adding together two ellipses (e.g., one elongated generally horizontally and another elongated generally vertically). In order to combine the shapes once properly located, a user action, such a “left clicking” the mouse pointer or the like is preferably done to connect the shapes.

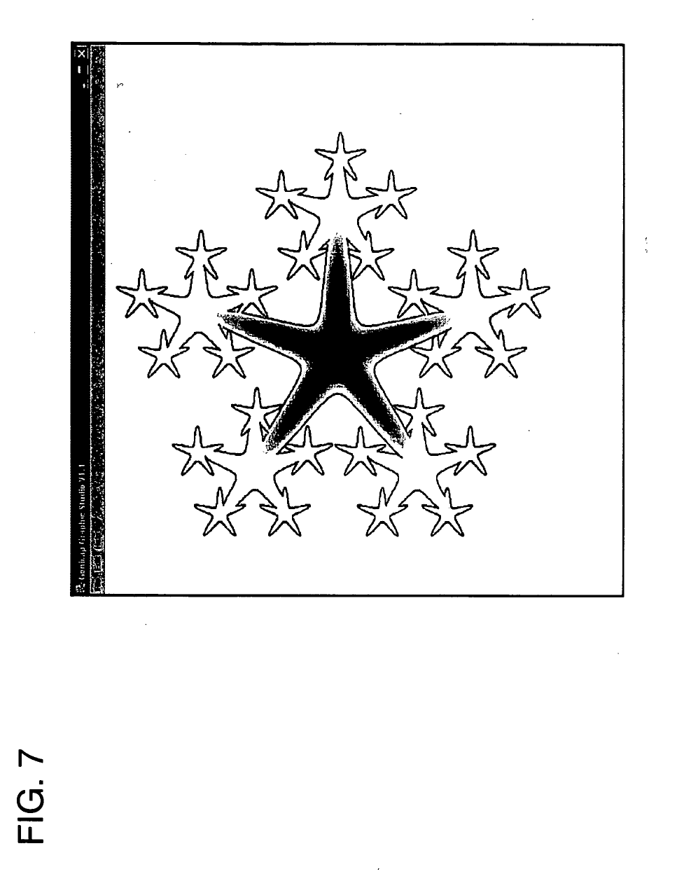

FIG. 7 shows an illustrative image shape created by the combination of a plurality of starfish-like shapes, which can be carried out in a similar manner to that described immediately above. In some examples, relatively complicated combinations of shapes can be carried out, such as, e.g., according to certain fractal-like production rules and/or other rules.

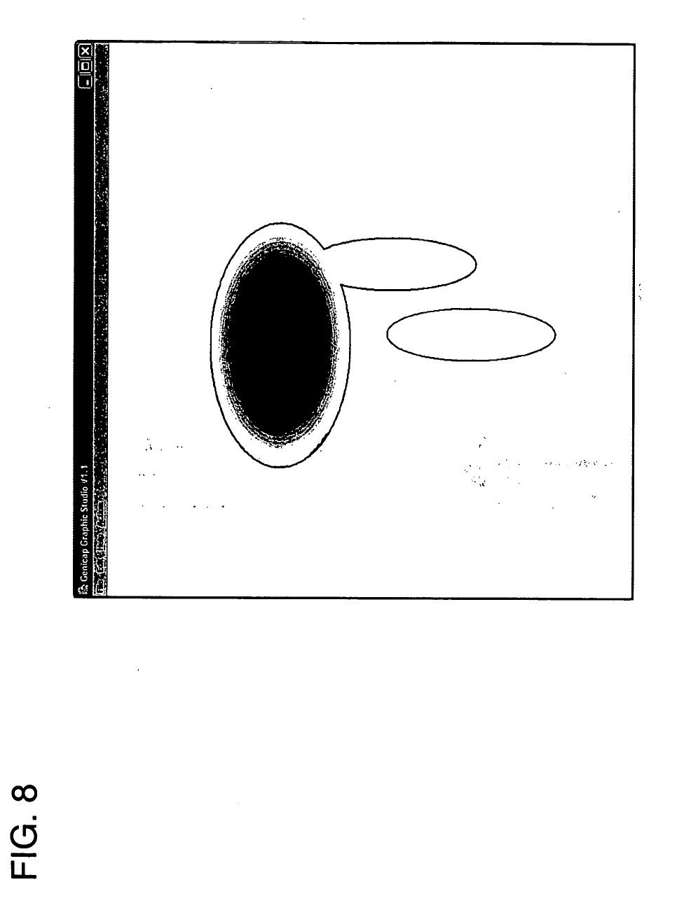

As detailed above, in some embodiments, the moulding of shapes can include the addition together of shapes (e.g., combining the union of two shapes together, such as, e.g., shown in FIGS. 6(A), 7 and 8) and/or the subtraction of one shape from another (e.g., combining the union of two shapes together, such as, e.g., shown in FIGS. 6(B), in which rather than the union of the two shapes in FIG. 6(A), a subtraction of one shape from the other is performed in FIG. 6(B)).

In some embodiments, moulding can include the moulding of two SUPERSHAPES, the moulding of a SUPERSHAPE with a non-SUPERSHAPE and/or the moulding of two non-SUPERSHAPES.

In some embodiments, moulding can be performed multiple times on the same set of shapes to be moulded, such as, e.g., illustrate in FIG. 7.

In some embodiments, with addition moulding, after moulding, the internal structure of both of the moulding together shapes is made to disappear such that the shapes have the appearance of uniting to form a single new combined shape.

In various other embodiments, various other moulding operations can be performed with the shapes, such as, e.g., any form of Boolean operation, any form of blending operation, multiplication operations, fractal composition operations and/or any other form of algorithmic procedure can be employed.

E. Coloring and/or Texturing Shapes:

In preferred embodiments, a graphical editor also enables the modification and/or selection of color properties. In some embodiments, a “properties” window, such as, e.g., that shown in FIG. 5(B) above, can be used to view and/or set colors defined for the shapes. In some embodiments, another coloring parameter can be used to set coloring characteristics within the shape. For example, in the embodiment shown in FIG. 5(B) a coloring parameter is set on “curve”. In addition, in some embodiments a texturing functionality can be provided through which, e.g., a user can assign specific selected textures (such as, e.g., selected from plurality of pre-designated textures, such as, e.g., sand-like, grain-like, liquid-like, rock-like, leather-like, mottled, granite-like, roughened and/or any other possible texture) can be assigned to a given shape and/or to any portion of a given shape.

F. GUI with a Large Choice of Primitives:

In preferred embodiments, a graphical editor is provided with the capability of enabling a user to choose from a large variety of primitives. In some embodiments, a user can “open a palette” or the like displaying a plurality of primitives. Then, upon selecting a particular primitive, another sub-pallet will open, with many more primitives to choose from (with certain modifications of the selected primitive).

In some embodiments, the primitives can be obtained either from computer memory and/or generated by the user (e.g., in substantially real time). They may be generated, e.g. from a range of parameters, which can be generated through permutations of, a random change of, or other variations of a subset of the parameters.

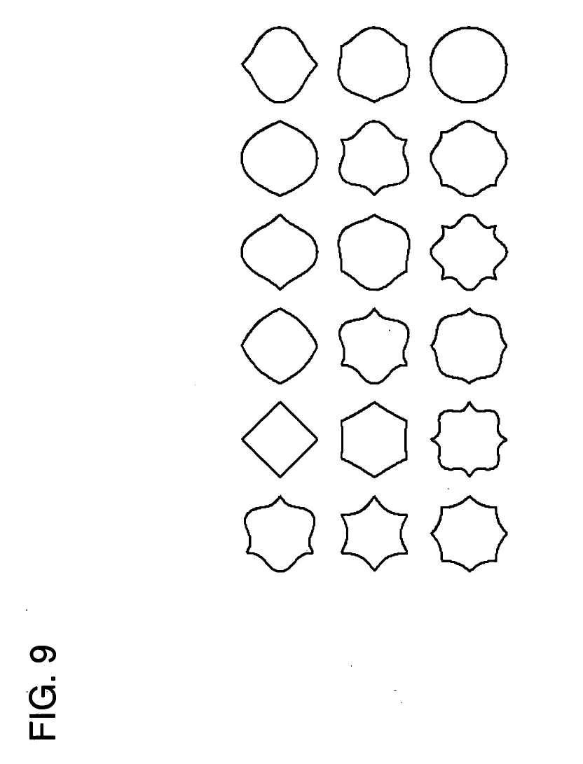

In some embodiments, the graphical editor can include a “genetic” algorithm that creates “genetic mutations” of a shape selected by a user according some schema (e.g., such schema may be pre-established and/or selected and/or modified by a user). For example, in a first step a user might be presented with one or more SUPERSHAPES (such as, e.g., a circle, a triangle, a square, a pentagon, and/or the like). If, for example, the user selects the circle, the computer can display a sub-pallet or the like of images for the user. In this regard, FIG. 9 shows an illustrative sub-pallet that can be displayed upon selecting a circle. In some embodiments, this creation of a “sub-pallet” can be repeated multiple times. For example, upon selecting one of the shapes displayed in FIG. 9, another sub-pallet subsequent to this displayed sub-pallet may be displayed showing shapes with parameter variations of the selected shape. In this manner, in one or more clicks, a user can have ready access to a much broader range of primitive shapes. In addition, the multi-stage modifications of shapes can assist in intuitive selection of shapes (e.g., where a common theme is established between pallets and sub-pallets between various shapes-such as, e.g., by imparting similar modifications of parameters to create sub-pallets). Moreover, in preferred embodiments, the shapes can even be further modified and/or changed using one or more of the techniques described herein.

G. Parameters as Functions (E.G., C-point Technology):

As described above, in some illustrative embodiments, in 2-D graphics environments, in 3-D environments and/or the like, one or more, or all, of the parameters can be functions. In these instances, the functions may vary for Π (phi). The functions can include any functions, such as, any mathematical equations, trigonometric functions, logarithmic functions, polynomial functions, Bezier functions and/or much more. In some embodiments, functions can be used for one or more of the exponents (e.g., n values), m, a, b, etc. In this regard, functions can be used in any of the SUPERFORMULA parameters described in the above-mentioned patent applications, described herein and/or described in any of the attachments hereto. In some embodiments, this may be referred to as “c-point” technology. It is a most general expression. It is more general, e.g., than Zhou and Khambamettu, who used functions only in the exponent in superellipses. (see full reference page 42) While the preferred embodiments described herein pertain to graphics editors and the like, any of the embodiments described in the above-referenced patent applications can employ one or more, or all, of the parameters as functions.

In some embodiments, the SUPERFORMULA is a parameterized function with up to, e.g., 6 parameters. In some embodiments, one or more of the parameters can be selected as numbers and/or moderated by the user and/or a computer. In some embodiments, the parameters need not be fixed, but can change (such as, e.g., as functions or according to certain choices). In some embodiments, one or more or all of the parameters can change according to a function, such as, e.g., along the rotation of the curve from 0-360°.

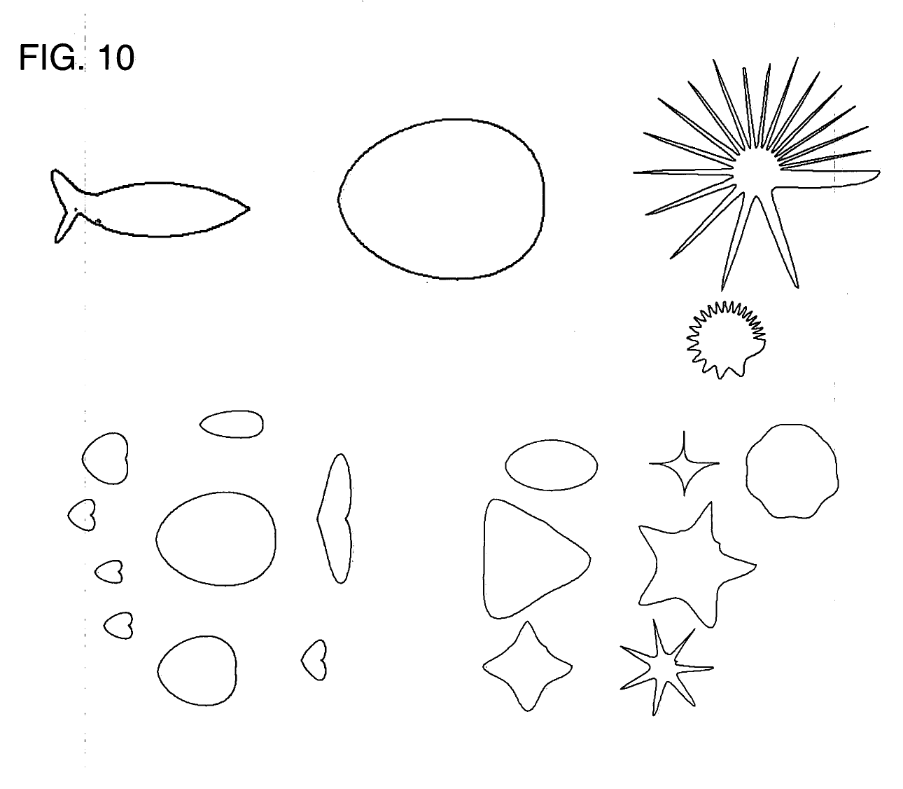

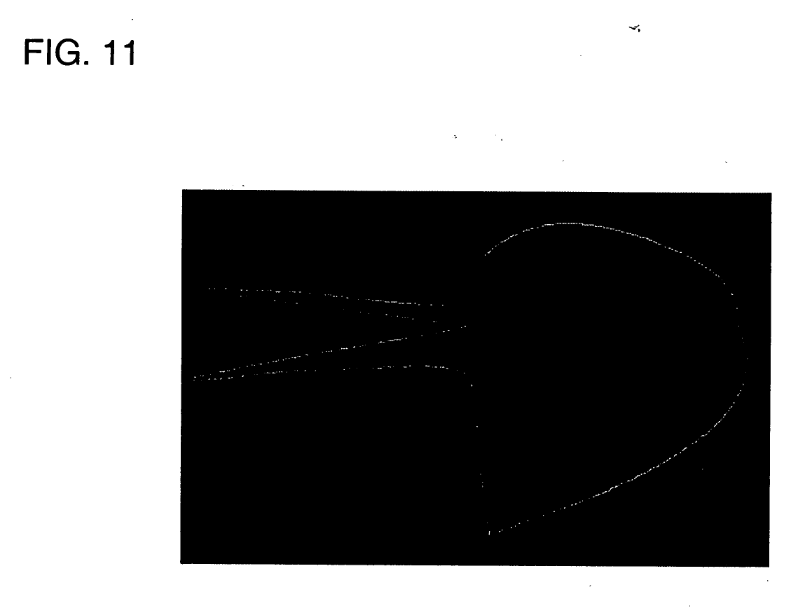

In some embodiments, a technology can be employed that is referred to herein as CROSSPOINT technology. In some embodiments, a user can select two points around a SUPERSHAPE and the application can enable a region between these two points (referred to as, e.g., “c-points”) to be modified without affected other portions of the SUPERSHAPE. In some embodiments, various operations on the region between the c-points (referred to as, e.g., the crosspoint region) can be employed, such as, e.g., any methods of modifying shapes as described herein. In some embodiments, the values of the SUPERFORMULA parameters can be modified between the c-points, such as, e.g., using any appropriate techniques. The various shapes depicted in FIG. 10 depict some illustrative shapes that have been constructed using c-point technology. In addition, FIG. 11 depicts an illustrative shape that has been created using this technology along with image coloring techniques. In some other embodiments, modifications can include free-form modification (e.g., free-form drawing) in cross-point regions and/or the ability to replace sections of a SUPERSHAPE in cross-point regions with other desired configurations, such as, e.g., straight lines, curves, and/or other features.

In preferred embodiments, c-points will provide interpolation functions in one SUPERSHAPE (e.g., with parameters as functions) or between SUPERSHAPES, such as, e.g., having a first SUPERSHAPE value set at one or more certain location(s)—such as, e.g., at 0° and 360° by way of example—and having a second SUPERSHAPE value set at one or more other location(s)—such as, e.g., at 180° by way of example—while the computer performs a process that interpolates between these values at regions between these designating locations (e.g., in the illustrative case at regions between these 0°, 180° and 360° locations).

In various embodiments, there are a variety of ways to modify the shapes with asymmetry. In some of the preferred embodiments, this is performed by use of a technique referred to as c-point technology, with an interpolation between different SUPERSHAPES, as demonstrated in FIG. 36. In some preferred embodiments, the asymmetry can be fully encoded, such as, e.g., has been the case in the present assignee's SUPERGRAPHX software discussed herein.

The upper curves shown in FIG. 36 are based on a square. For a good representation in Adobe Illustrator, at least 8 Bezier control points are needed for a square and ten or more points for the shapes above. In lower curves, the shapes are based on a heptagon and five c-points. These shapes, thus, required 18 or more Bezier control points. In contrast, with a SUPERFORMULA vector, there are about 6 c-points and 3-5 different parameter values per c-point. In addition, the c-points remain fixed and do not require recalculation all the time. With reference to FIG. 36, in the shapes below, only one parameter is different from the shapes above. In contrast, for Bezier generation, every turn the number of Bezier control points is greatly increased.

In various embodiments, there are a variety of ways to do this, such as, e.g., using interpolation functions between two or more shapes, or using a function instead of constant parameters in the formula.

H. Combining SUPERSHAPES using Blending and/or the Like:

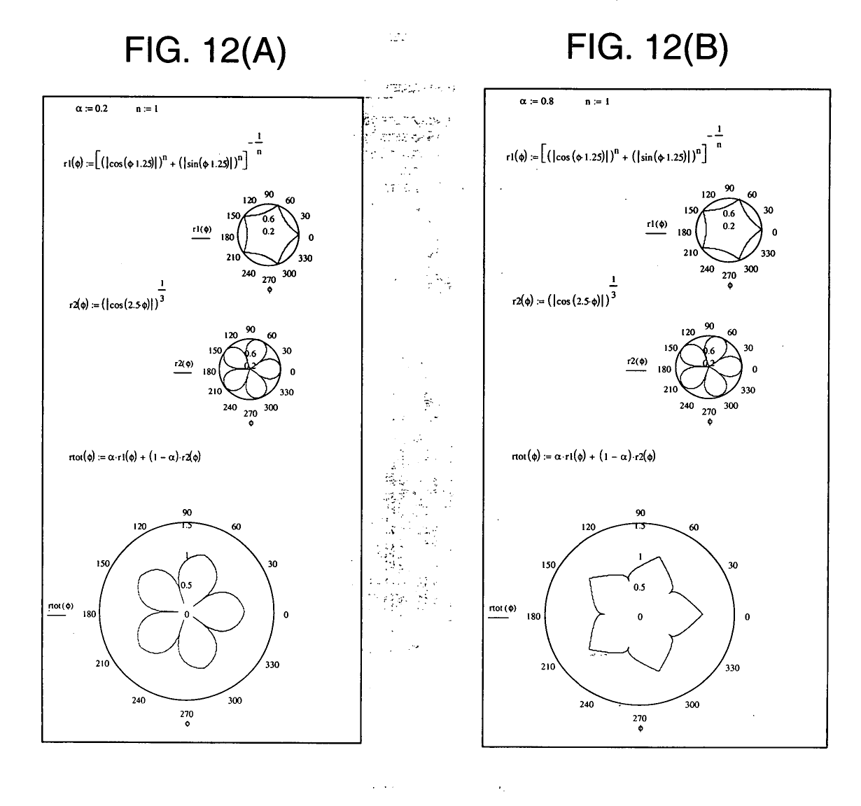

In some embodiments, two or more SUPERSHAPES can be combined using addition, multiplication and/or the like. In addition, in some embodiments, a blending function can be used. For example, in some embodiments, the functions (such as, e.g., addition and/or multiplication functions) can be balanced using a blending value α. FIGS. 12(A) and 12(B) show two illustrative examples in which a value of a is changed. As shown in these illustrative examples, depending on the values of the original shapes shown (e.g., a pentagon and a flower shape), one of the original shapes may be retained more or less in the resulting shape. In some embodiments, blending can be done for more than two shapes, such as, e.g., for n shapes with blending factors an for each of the n shapes. If the sum of all αₙ equals “one,” the area can equal to the sum of the individual shapes. In some illustrative embodiments, a sum can involve, for example, a Fourier series. While addition of shapes is employed in some embodiments, multiplication of shapes can also, or alternatively, be employed in some embodiments.

In the embodiments shown in FIG. 12(A) and 12(B), respective pentagons (at the top of the page) are combined with respective 5-fold flowers (at the middle of the page). The results are depicted in the two blended shapes (at the bottom of the page). For the left-side example, the value of a is 0.2 (e.g., the pentagon plays a minor role). For the right-side example, the value of a is 0.8 (e.g., the flower plays a minor role). In this context, for α=1, the original pentagon is obtained, while for α=0 the original flower is the results.

I. Piecewise Connections

In some embodiments, piecewise connections, e.g., adding together of small pieces of various SUPERSHAPES can be performed. In some examples, this can be performed in order to create new shapes based on piecewise combinations of portions of SUPERSHAPES. In addition, in some embodiments, this could be used to approximate a given shape with a piecewise approach (such as, e.g., for analysis of shapes). In some embodiments, a piecewise composition could, for example, be based on any desired representation, such as, e.g., polar graphs, on XY (signal-like) graphs, the knitting together wavelets modulated with the SUPERFORMULA, and/or the like.

### Illustrative 3-D Embodiments

In preferred embodiments, 3-D graphics and the like using the SUPERFORMULA can easily be expanded into three dimensions. In this regard, the notion of spherical product (Barr, 1981), well known in the art of computer graphics, may be generalized into SUPERSPHERICAL product. In this regard, a product of any two SUPERSHAPES can be obtained. An expression of these SUPERSPHERICAL products can be very simple and can simply use, e.g., merely the expression of two 2-D shapes.

According to some embodiments, a variety of 3-D shapes can be more readily defined, such as, e.g., to create some well-known primitives. In addition, in some embodiments, extrusions, revolves and/or other operations can also be performed. Extrusions and/or revolves are widely used functions in computer graphics. The revolve function can be a generalization of a torus or toroid. In some embodiments, the path and/or the cross-section can involve SUPERSHAPES. In addition, in some embodiments, in three dimensions self-intersection can be avoided. In addition, knots, helices and/or spirals can readily be made as well with similar procedures.

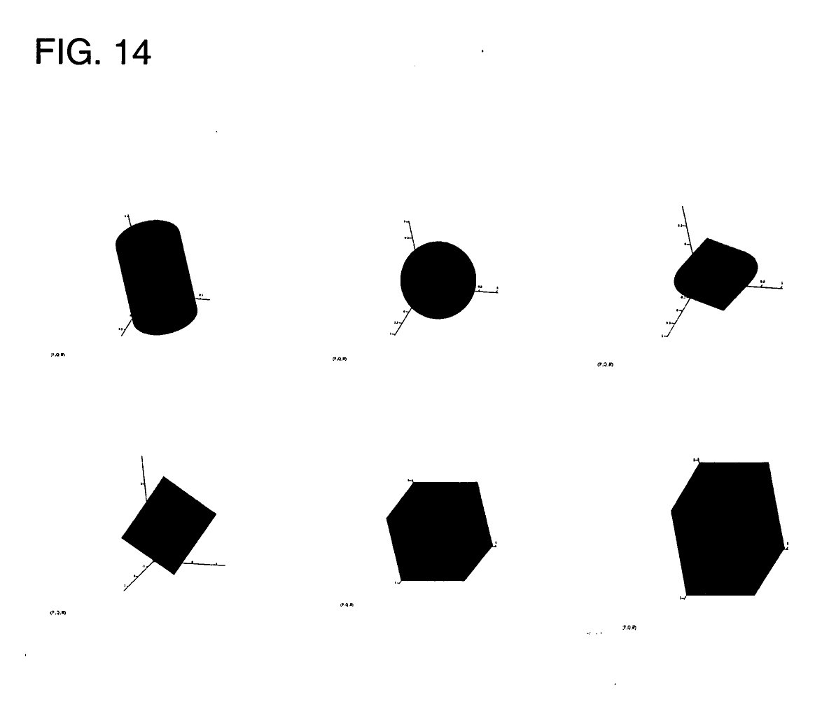

Theoretically, the SUPERFORMULA can include 6 different parameters, but typically (such as, e.g., in certain examples below) size parameters a and b are equal one (or are a constant) and/or n₂ equals n₃, so that, in some preferred embodiments, only 4 parameters are taken into account in some representations of the SUPERFORMULA. For toroids, an additional ‘offset’ parameter is used. In addition, for a self-avoiding 3-D shape, another parameter is used. Thus, in total, the shapes shown in FIGS. 14, 15 and 16, by way of example, can be created with only 10 numbers to define each of their illustrated 3-D shapes.

In addition, all 2-D SUPERSHAPES can be made with a similar procedure. As with the two-dimensional case, the SUPERFORMULA itself provides the internal metrics of these 3-D shapes. Accordingly, all of these 3-D shapes can be considered as “Spheres.” As in the two-dimensional case, the capital S can be used to denote the general set of all such shapes, of which the (unit) sphere is a special case. Alternatively speaking, there exists a unique one-to-one mapping from the (unit) sphere to any “Sphere.”

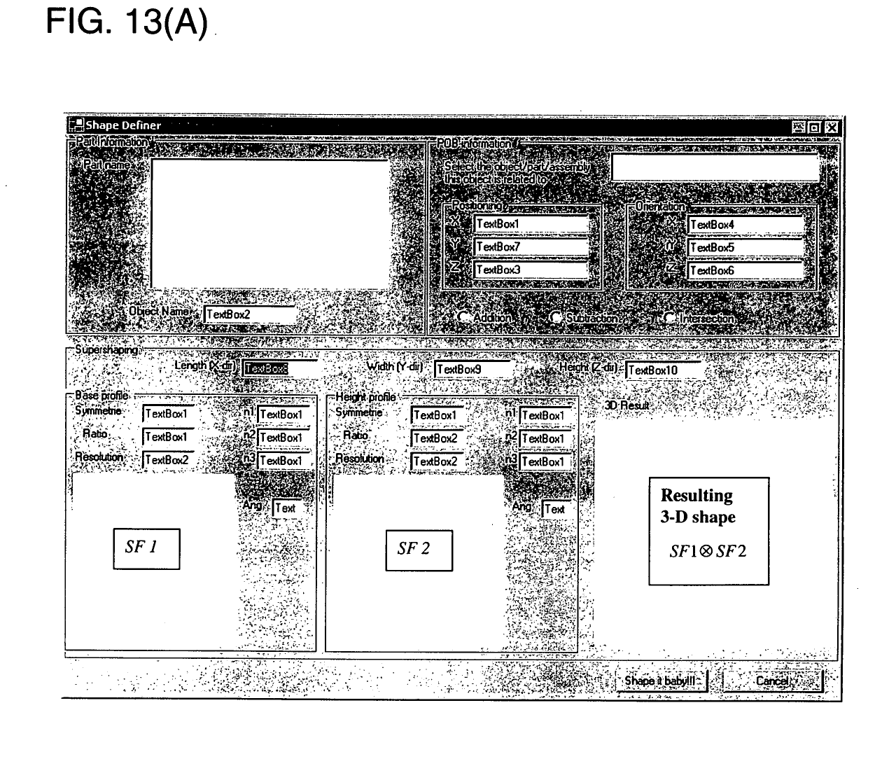

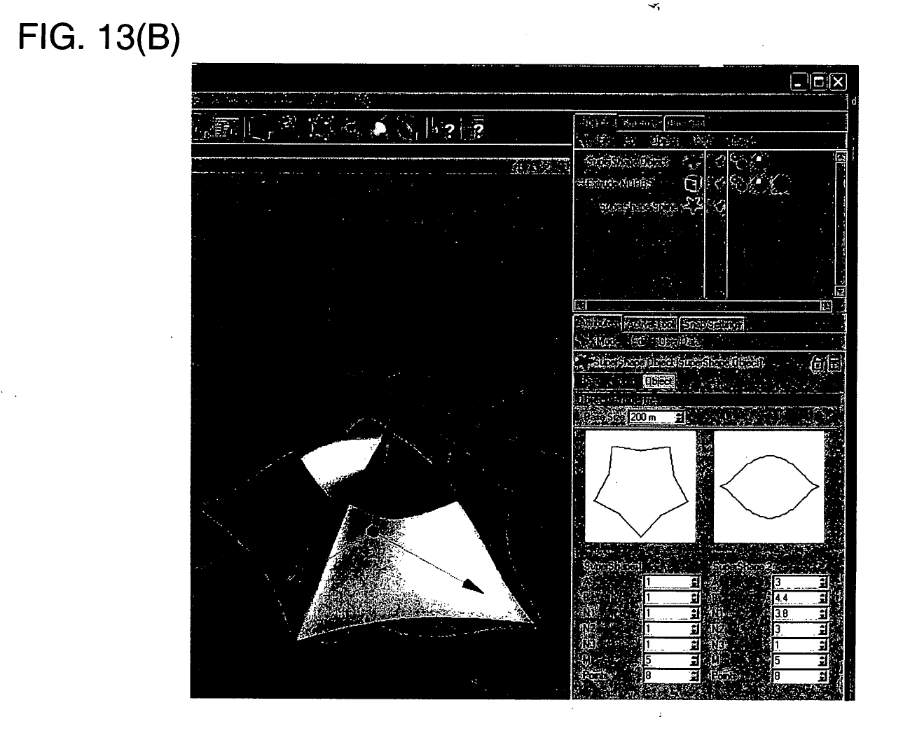

The 3-D SUPERFORMULA provides an extension from classical superquadrics, in which both of the original circles in the spherical product are shapes defined by the SUPERFORMULA (SF1 and SF2). In view of this principle, in some preferred graphical editor embodiments, double 2-D windows can be advantageously utilized in a preferred graphical user interface, such as, e.g., depicted by way of example in FIGS. 13(A) and 13(B), showing two illustrative GUIs.
A. A Spherical Product is Defined as:

$$\begin{matrix}\begin{matrix}h ( θ ) = [ \begin{matrix}cos θ \\ sin θ\end{matrix} ] & & & m ( ϕ ) = [ \begin{matrix}cos ϕ \\ sin ϕ\end{matrix} ]\end{matrix} \\ θ ∈ [ - π ; π [ and ϕ ∈ [ - π / 2 ; π / 2 ] \\ r ( ϕ , θ ) = m ( ϕ ) ⊗ h ( θ ) \\ [ \begin{matrix}x \\ y \\ z\end{matrix} ] = [ \begin{matrix}cos θ \cdot cos ϕ \\ cos θ \cdot sin ϕ \\ 1 \cdot sin ϕ\end{matrix} ]\end{matrix}$$

B. A SUPERSPHERICAL Product, using SUPERFORMULA 2-D Shapes (SF1 and SF2) can be Defined as:

$$\begin{matrix}\begin{matrix}h ( SF1 , θ ) = [ \begin{matrix}cos θ \cdot SF1 \\ sin θ \cdot SF1\end{matrix} ] & & & m ( SF2 , ϕ ) = [ \begin{matrix}cos ϕ \cdot SF2 \\ sin ϕ \cdot SF2\end{matrix} ]\end{matrix} \\ r ( SF1 , θ ; SF2 , ϕ ) = h ( SF1 , θ ) ⊗ m ( SF2 , ϕ ) \\ [ \begin{matrix}x \\ y \\ z\end{matrix} ] = [ \begin{matrix}cos θ \cdot SF1 \cdot cos ϕ \cdot SF2 \\ cos θ \cdot SF1 \cdot sin ϕ \cdot SF2 \\ 1 \cdot sin ϕ \cdot SF2\end{matrix} ]\end{matrix}$$

As indicated above, FIG. 13(A) shows a graphical user interface (GUI) in which two SUPERFORMULA shapes (referred to as SV or SF) can be defined (see bottom left and center of the GUI) and a resulting shape SF1\mathring{x}SF2 is depicted on a right lower side of the GUI.

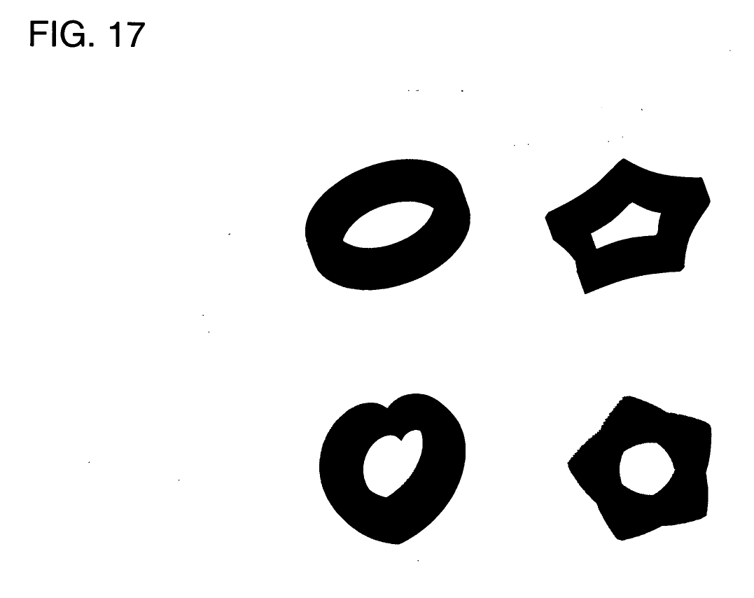

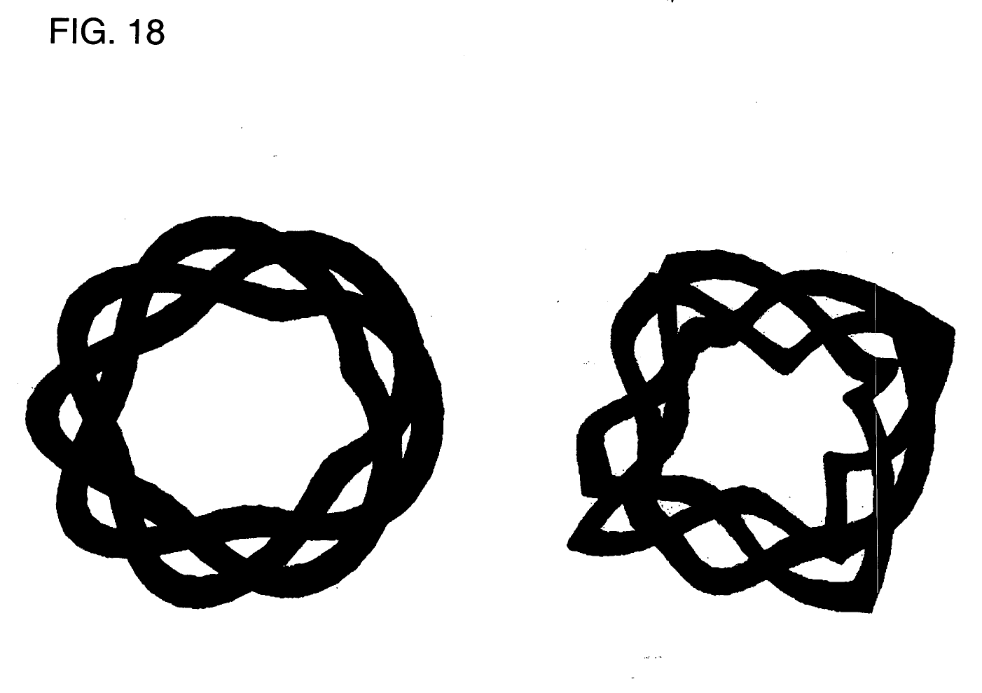

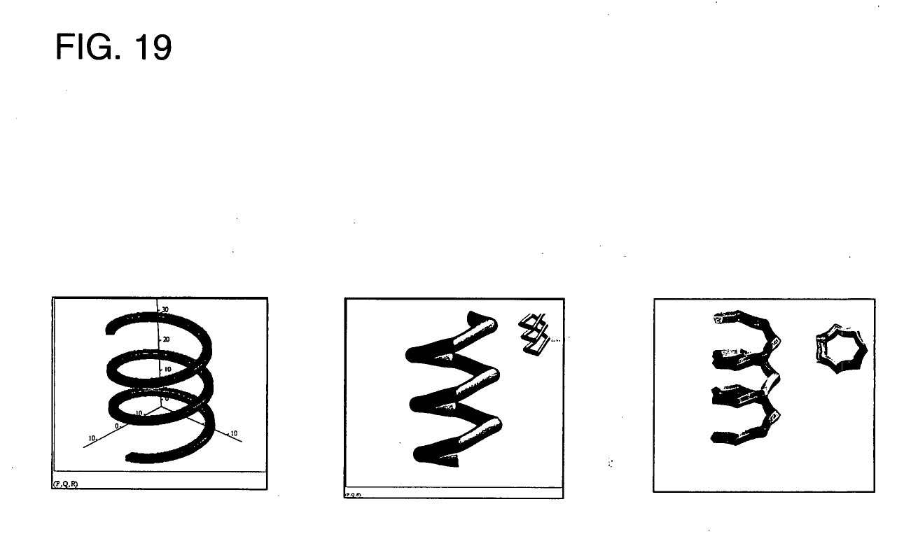

FIGS. 14-19 show some illustrative examples of SUPERSPHERICAL products. As shown, some of these products are similar to classical primitives. In some embodiments, one of two shapes can be revolved along a path defined by the other shape. FIGS. 14-16 demonstrate instances where the two shapes are centered in the same origin. If the shape defining the path is larger than the sweeping shape, torus-like revolve functions can be achieved, which can be, e.g., closing or self-intersecting (such as, e.g., seen in the illustrative shapes shown in FIG. 17) or self-avoiding (such as, e.g., seen in the illustrative shapes shown in FIG. 18). In some embodiments, there can also be a movement in a Z direction (such as, e.g., seen in the illustrative shapes shown in FIG. 19).

In addition, all of the 2-D modifications above can involve any two shapes. Accordingly, in some illustrative embodiments, numerous shapes (such as, e.g., by way of example that shown in FIGS. 14-19) can be developed based on a single formula. In contrast, in existing computer graphics methods, different models and procedures are common.

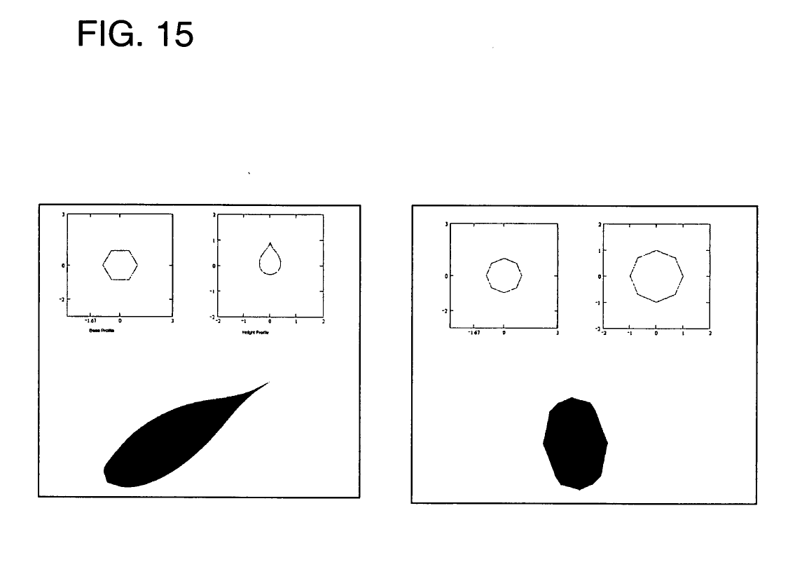

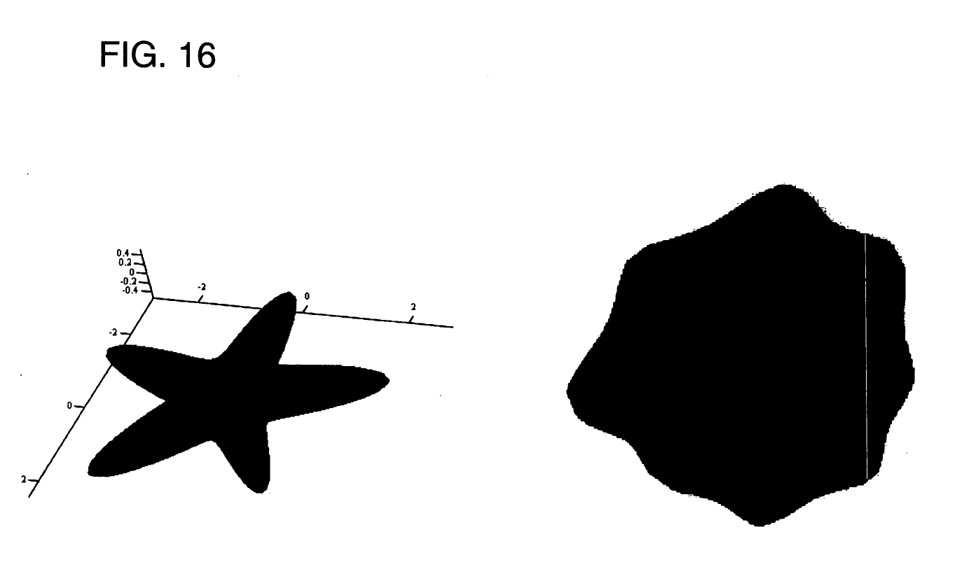

FIG. 14 shows some “classical” primitives that can be created using just 10 bytes in some embodiments. FIGS. 15 and 16 show some “additional” examples of primitives that can be created using just 10 bytes in some embodiments. FIG. 17 shows some illustrative “revolved shapes” that can be created using just 10 bytes in some embodiments. FIG. 18 shows some illustrative “superspherical knots, using self-avoiding aspects” that can be created using just 10 bytes in some embodiments. FIG. 19 shows some illustrative spirals (e.g., springs) that can be created having SUPERSHAPE cross-sections using just 10 bytes in some embodiments. All the shapes shown in FIGS. 14-19 can be defined in 10 numbers or less (e.g., which can be equal to about 10 bytes).

It should be understood based on this disclosure that the various examples described in this application can be extended with various other procedures. For example, in computer graphics of 3-D, shapes can be combined in, e.g., a Constructive Solid Geometry sense CSG modelling, defined by Boolean operations in 3-D.

In some illustrative embodiments, a SUPERFORMULA-based modeller (such as, e.g., a 2-D and/or 3-D modeller) can advantageously be used in a variety of applications, ranging from CAD/CAM, to computer gaming, to computer animations, to wireless (e.g., cellular) telephones, wirelessly networked personal digital assistants (PDAs) and/or displays of other wirelessly networked devices, to various other applications (such as, e.g., any applications described in the above-referenced applications incorporated herein by reference).

The SUPERFORMULA and Implicit Objects in Computer Graphics:

In computer graphics applications, parametric descriptions with intrinsic descriptions are currently popular, but implicit objects are rapidly gaining acceptance. They provide an extrinsic description and unify geometric and volumetric modelling and are very suitable for constraint definitions. See, e.g., Velho, et al. (2002) Implicit Objects for Computer Graphics, Springer Verlag. While parametric surfaces allow easy enumeration of points, classification of points is more straightforward with implicit objects. While the range of implicit objects has so far been limited, the SUPERFORMULA provides a powerful and unifying framework for implicit objects.

In addition, for implicit objects a number of operations, such as range operations (such as, e.g. density change or complements), domain operations (such as, e.g., affine mappings or (physically based) deformations), blend operations and combinations (such as, e.g., n-ary operations such as CSG) are straightforward. For characterization of points, point-membership classification is straightforward using either equality or inequalities. Using inequalities, density maps (such as, e.g., colors, heights, etc.) are easily defined. Since SUPERFORMULA 3D shapes can be expressed as implicit functions all of the above and other operations can be performed with SUPERSHAPES.

In that regard, differentiable n-ary operations based on R-functions, such as differentiable Boolean operations can be implemented directly. R-functions are in fact real functions of real variables, and they allow one to write an equation for a domain of a shape in the same way as one writes a logical expression. So, for any volume V, a real continuous (and differentiable) function can be written that is positive inside, zero on and negative outside the shape. The surfaces can then be used, for example, to solve boundary problems. Since for R-functions one has to use implicit functions, they are currently not widely used because of the widespread use of parametric curves. Thus, SUPERSHAPES in two and/or three D greatly enhance the capabilities of R-functions and modelling, allowing for compact analytic expressions of composite shapes.

As the SUPERFORMULA allows for both parametric expression and implicit function, the advantages of both, namely enumeration and classification of points, can be combined. This variety of possible operations and basic representations makes the SUPERFORMULA one of the most powerful shape representations, and certainly, a very uniform representation too.

### Product Requirements in Some Illustrative Embodiments

In some illustrative embodiments, various procedures for a SUPERFORMULA-based 3-D modeller can include aspects set forth in Attachment A of the above-referenced priority provisional application Ser. No. 60/479,177 entitled Computer Graphics Systems and Methods, filed on Jun. 18, 2003, to Johan Gielis, et al. (incorporated herein in its entirety). In this regard, that Attachment A shows a detailed summary of Product Requirements according to some illustrative and non-limiting embodiments employed in computer 3-D modelling. It should be understood based on this disclosure that Attachment A shows some illustrative and non-limiting examples and that various other embodiments and implementations can be created based on this disclosure and the concepts herein.

Illustrative Examples of 3-D Modelling:

Similarly, Attachment B of the above-referenced priority provisional application Ser. No. 60/479,177 entitled Computer Graphics Systems and Methods, filed on Jun. 18, 2003, to Johan Gielis, et al. (incorporated herein in its entirety) shows some other illustrative embodiments of 3-D modelling according to some illustrative and non-limiting embodiments of the invention. It should be understood based on this disclosure that that Attachment B shows some illustrative and non-limiting examples and that various other embodiments and implementations can be created based on this disclosure and the concepts herein. In reference to the illustrative 3-D modelled images shown in Attachment B, among other things, one of ordinary skill in the art should appreciate based on this disclosure that—by way of example only—various images shown (such as, e.g., vehicles, buildings, aircraft) could readily be used in the creation of computer games, computer animations and/or more (such as, by way of example only, where vehicles or the like are driven past buildings or the like, such as, e.g., in playing a computer game or in showing an animation).

### Additional Illustrative Embodiments

1. Illustrative 3D Shape Creator Application

In some illustrative embodiments, a 3D shape creator application can be developed as described in this section. In this regard, as described above, in some embodiments, the SUPERFORMULA can be represented as follows:

$$r ( θ ) = {[ {\vert \frac{cos ( \frac{1}{4} m θ )}{a} \vert}^{{n}_{3}} + {\vert \frac{sin ( \frac{1}{4} m θ )}{b} \vert}^{{n}_{2}} ]}^{- 1 / {n}_{1}} .$$

As described above, this representation is based on the equation of a circle. Shapes created can, e.g., have different symmetries, sides can fold inwards or outwards, corners can be sharp or rounded, etc. Generally speaking, there are three groups of parameters for each 2D shape:
Symmetry (factor m);
Shape (exponents n1, n2, n3);
Size (a and b).

In some basic embodiments, a 3D version of a SUPERSHAPE is based on a parametric formulation of a simple combination of two 2D SUPERSHAPES, which are perpendicular to each other. This can be conceptualized as follows: if you think of a sphere, in any section it is a circle, and any perpendicular section is also a circle. Similarly, a small section through a cube is a square, and the perpendicular shape is also a square. Likewise, for a cylinder, one section is a circle, and its perpendicular section is a rectangle.

Accordingly, in some examples, an easy-to-use interface can be created based on such sections, as follows.
SUPERSHAPE 1: defines the cross-section; and
SUPERSHAPE 2: defines the perpendicular section

Conceptually, SUPERSHAPE 1 can be thought of as an object, which is swept along a certain path, described by the SUPERSHAPE 2. By way of example, a cube can is a square swept along a square path. This can be formulated mathematically through the superspherical products as operation SF1\mathring{x}SF2, the product of object and path. Some illustrative examples are demonstrated below:
square\mathring{x}square=cube;
circle\mathring{x}circle=sphere;
circle\mathring{x}rectangle=cylinder;
circle\mathring{x}Big circle=torus.
   In some illustrative examples described below, these principles provide straightforward expressions for 3D shapes and facilitates the development of easy interfaces for creating 3D shapes. In some illustrative embodiments, a variety of 3D shapes can be readily defined, many of which are well-known primitives, using the well-known extrusion and revolve operations. These latter operations are two of the most widely used functions in 3D computer graphics. Typically, the revolve function is a generalization of a torus or toroid, in which both the path and the cross section can be SUPERSHAPES.

According to some illustrative embodiments, a 3D shape creator can, thus, be provided as, e.g., a powerful standalone application. For example, an application can be readily created that is capable of running on any operating system, including, e.g., Windows configurations, such as, e.g., MS Win 98, Win ME, Windows 2000, Windows NT, Windows XP and/or the like.

Illustrative User Interface

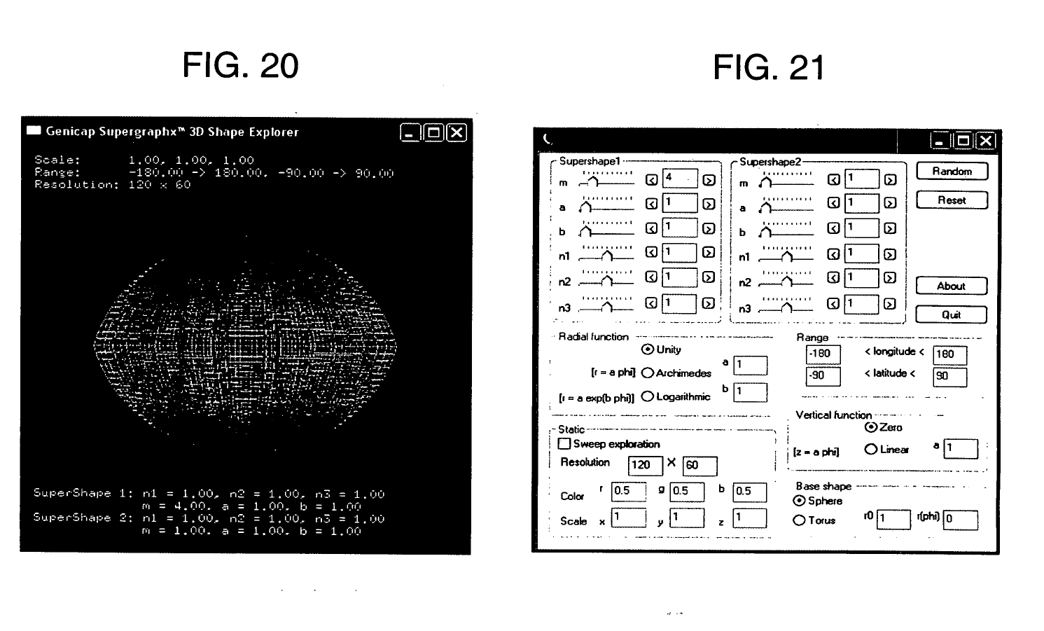

FIGS. 20-21 show an illustrative graphical user interface (GUI) that can be presented to a user in some illustrative 3D shape creator software applications. In this regard, FIG. 20 shows an illustrative shape window that can be presented which shows the produced shape. In some illustrative examples, additional commands (e.g., for creating and/or varying shapes, etc.) can be entered via a pointer device (such as, e.g., by a right-mouse click). In some illustrative examples, such as shown in FIG. 21, a separate parameter interface window can also be provided. In such a separate parameter interface window, a set of parameters can be selected and/or modified.

In some illustrative example, when the 3D shape creator program with an interface as shown in FIGS. 20-21 initially starts up, a wire-frame model of a simple 3D object can be set for automatic display. In some illustrative embodiments, this illustrative shape can be modified using, e.g., the interface shown in the shape window in FIG. 21 and/or menus that may be made available, for example, through the usage of the right-mouse button (RMB).

Rendering the Shape

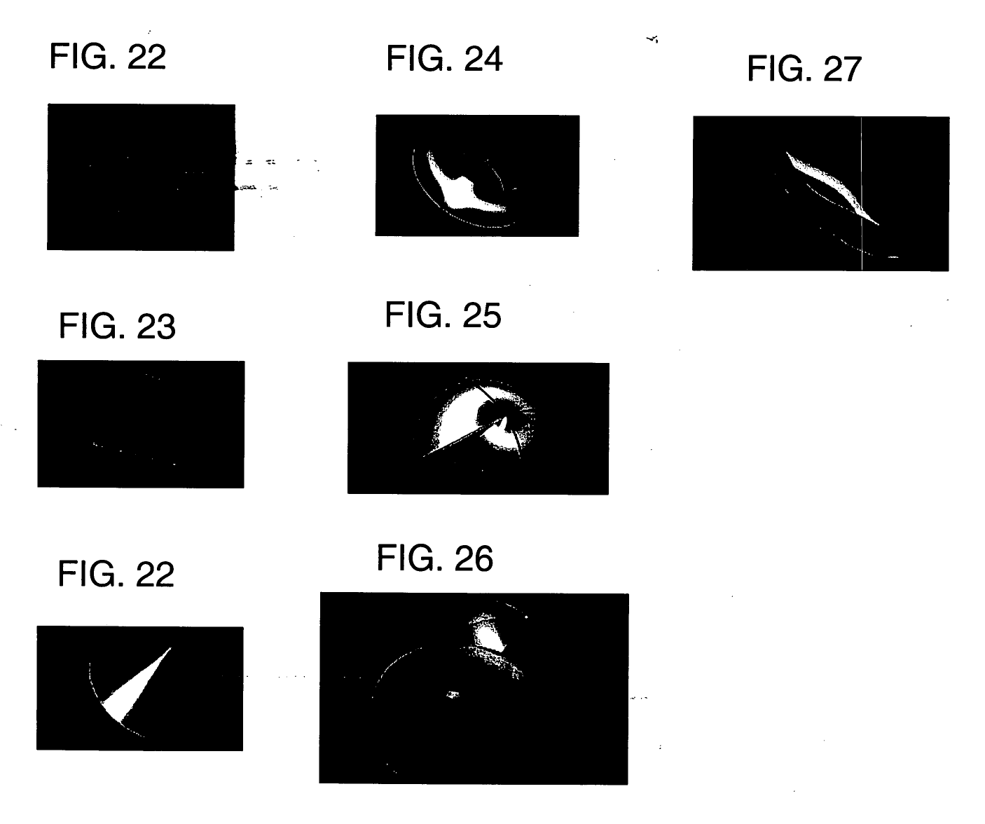

In some illustrative embodiments, the shape displayed can be represented in a variety of renderings. For example, in some embodiments, a wire-frame model rendering can be used, such as, e.g., shown in FIG. 22, that is essentially a minimal form showing only some lines describing the contour of the shape. In another example, as shown, e.g., in FIG. 23, a shaded-model rendering can be used, such that, e.g., the shape can be essentially filled and appear to be a full 3D object. In yet another example, as shown, e.g., in FIG. 24, a specular-model rendering can be used, in which a light source is depicted as shining on the created object (such as, e.g., from the front-side as seen by the user). In some illustrative embodiments, the rendering menu can be accessible via a GUI and/or via a right mouse button (e.g., when the cursor is in the shape window).

Coloring the Shape

In some illustrative embodiments, in addition to gray-shading of the shapes, some coloring schemes can be applied to the displayed forms. By way of example, in some embodiments, a user can select from one or more of the following possibilities:
Constant color: only gray shading used.
Latitude, linear (blue->green->red).
Longitude, linear (blue->green->red).
Latitude, circular (red->blue->green->red).
Longitude, circular (red->blue->green->red).
   In some embodiments, another effect can be provided (referred to as “toggle grid lines”) which allows the user to put an additional grid of blacked lines on top of the shape (or elsewhere on the shape) to further accentuate its form. In some illustrative embodiments, this coloring facility may also be made available from the “Color Ramp” menu in the shape window.

In addition, in some embodiments a texturing functionality can be provided through which, e.g., a user can assign specific selected textures (such as, e.g., selected from plurality of pre-designated textures, such as, e.g., sand-like, grain-like, liquid-like, rock-like, leather-like, mottled, granite-like, roughened and/or any other possible texture) can be assigned to a given shape and/or to any portion of a given shape.

Viewing the Shape

In some illustrative embodiments, using the left-mouse button (LMB) in the shape window, a user can rotate the shape in 3 dimensions. For example, a user can push and drag the LMB around to view a shape from all sides.

In some embodiments, a user can also use the application to have the shape automatically pass before the user's eyes (e.g., in a substantially continuous manner). In some illustrative embodiments, a user can press an activation key in the shape window, so as to perform an automatic rotation of the shape (e.g., in one direction). In some embodiments, the user can increase and/or decrease the speed.

In some embodiments, a user can zoom in and/or out on a particular portion of the displayed shape (such as, e.g., using the + and − keys).

In some embodiments, a user can also drag the displayed shape in the shape window to another position (such as, e.g., using the LMB in combination with the SHIFT key).

Changing the 3D Shape

As described in detail above, in this illustrative embodiment of a 3D shape creator, each shape can described by a set of parameters: m, a, b, n1, n2 and n3.

In the preferred embodiments, the parameters that represent the shown shapes are visible at all times in both windows, but, preferably, they can only be modified from the parameter window. In this regard, in the preferred embodiments, the values of any parameter can easily be changed in one or more of the following ways:
Sliders
In this regard, a user can simply drag the slider to a new position using the user's mouse (e.g., LMB) to a new position to generate a respective new shape.
Textboxes
In this regard, the actual values of the parameters are preferably reflected in the textboxes, and, preferably, a user can change these values to generate a respective new shape. In some illustrative embodiments, the parameters can be edited to within values in increments of 0.001.
Arrows
In this regard, a user can increase or decrease a value by clicking on the right or left arrow of a specific parameter to generate a respective new shape.

In some embodiments, the numerical control via the sliders and/or arrows can be varied by the provision of a “magnification” key(s) which enables the increments achieved to be varied, such as, e.g., each step is 0.01; or each step is 0.1; or each step is 10; or the like.

In some embodiments, another way of obtaining a new 3D SUPERSHAPE is by pushing a Random button. In this regard, upon pressing Random, the application will preferably generate a set of random values for each of the parameters and show the result in the shape window. This can be an interesting way for a user to explore various SUPERSHAPES. In some alternative embodiments, the computer can be used to generate alternative values that may not be entirely random, but that may be created substantially randomly, but within certain confines and/or rules.

Exploring Shape Variations

In some embodiments, the application can include a feature that enables the user to explore shapes by small incremental changes on a per-parameter basis. For example, in some embodiments, an “Explore” key can be provided in a menu (e.g., upon a right mouse button click or the like). In some embodiments, the Explore key enables a user to select from a menu any parameter that the user desires to explore. Then, the program will vary the given parameter of the SUPERSHAPE (e.g., SUPERSHAPE 1 or 2) in an incremental or step-wise manner from a current value to a maximum value. In some embodiments, when the maximum value is reached, it will start off again from its minimum value. Concurrently, as the value is changed, a new shape is preferably shown in the shape window, giving the impression that the shape continuously changes. Preferably, the user can cause this exploration to be stopped using a ‘Stop’ entry in the Explore menu. In some alternative embodiments, the Explore functionality can also decrease values incrementally or step-wise. In some other embodiments, the Explore functionality can also be used to increase and/or decrease values of more than one parameter concurrently, such that a more complex transformation may be demonstrated. In some embodiments, the Explore functionality can increment across a specific range of values. In addition, in some embodiments, the Explore functionality can enable the system to perform explorations that ‘sweep’ between minimum and maximum values upwards and/or downwards. In some embodiments, this can be achieved by checking a “sweep exploration” checkbox in a parameter window.

Exporting Shapes and Common File Formats

In preferred embodiments, the shapes created can be saved to an external file. In preferred embodiments, a wide variety of file formats are available to which the created shapes can be saved. By way of example, in some embodiments, at least the following file formats are supported:
GENICAP SUPERGRAPHX Format (GSF): This is a file format by GENICAP, the assignee of the present invention, that represents SUPERSHAPES. Using this format, complex 3D shapes can be described very compactly, reducing file-sizes by a factor of 1000 or more in relation to other file formats. In some preferred embodiments, the GSF file format can be used as a common transport format between some or all applications (e.g., so as to greatly enhance communications and/or the like).
OBJ: This is Alias Wavefront's 3D standard object file format (.OBJ).
STL (STereoLitography): The stereolithography format (.STL) is an ASCII or binary file used in manufacturing. It is a list of the triangular surfaces that describe a computer generated solid model. This is the standard input for most rapid prototyping machines.
Drawing Interchange Format: The Drawing Interchange Format (.DXF)-known Autodesk file format. It allows export of 3D shapes.
PovRay: This open-source package allows 3D scenes to be described in an own language.
TARGA: The TARGA file format (.TGA) can be used to quickly produce a 2D bitmap image.
VARIOUS OTHER FORMATS: various other file-formats may be supported based on circumstances.

In some illustrative embodiments, to export a shape into an external file format, the user can, for example, click a RMB file-menu when in the shape window and select a format of the user's choice (e.g., from a menu or the like). In the preferred embodiments, since a common type of information is represented: e.g., SUPERSHAPES, a common file format is used to represent this information. Among other things, the use of a common file format can have some notable advantages in this context, such as:
enabling the exchange of information between products;
enabling common libraries to be built that can be used in any supporting product;
enabling the provision of a common (e.g., likely free) downloadable viewer program that can facilitate use of this new technology;
enabling all products to support a same external file format.

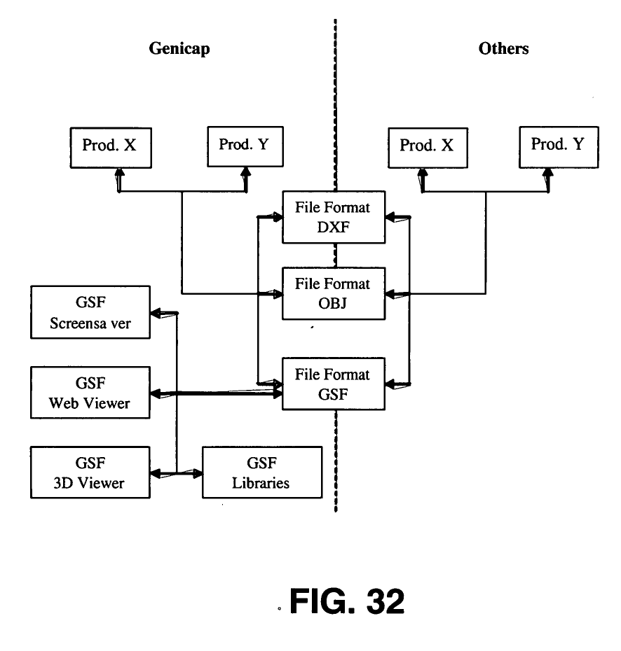

By way of reference, FIG. 32 demonstrates an illustrative common file format strategy that can be implemented in some illustrative embodiment (with GENICAP, the assignee of the present invention depicted verses other company products). As illustrated, in preferred embodiments the products will support some common defined file formats, such as, e.g., .DXF (Autodesk), .OBJ (Wavefront), .TGA (TARGA), etc. In addition, under this strategy, GENICAP's products also define an own external format .GSF (GENICAP SUPERGRAPHX Format), and, some applications may only support this .GSF file format.

In some embodiments, the information can be coded using defined file standards, such as, e.g., XML. Among other things, SUPERSHAPE files can be represented as XML documents and an abstract grammar can be defined for SUPERSHAPES using, e.g., DTD (Document Type Definition). In addition, SUPERSHAPES can also be coded using SCG (Scalable Vector Graphics) in some embodiments.

Thus, in the preferred embodiments, information regarding the common file formats are into a GENICAP Class Library (GCL), such that all products can use the common methods for importing and exporting.

Advanced SUPERSHAPES

In some illustrative embodiments, as shown in FIG. 21, the user interface can enable the creation of some specific advanced shapes. These advanced shapes (as well as the various parameter selection features described above) can preferably be combined in any way to obtain numerous and imaginative shapes very quickly and easily.

Base Shapes

As shown at the bottom right side of FIG. 21, in some illustrative embodiments, two types of base shapes are supported:
Spherical shapes: In this regard, generally speaking, all forms of shapes based on parameter selection within the SUPERFORMULA can be considered as spherical.
Torus shapes: In this regard, these forms are ring-like and allow interesting shapes to be generated. In this regard, in the illustrative embodiment shown in FIG. 21, two additional parameters can be set for tori: a) r0: this allows the radius of the torus to be selected; and b) r(phi): this allows the cross section of the torus to be gradually reduced and inverted by a factor. By way of example, FIG. 24 depicts an illustrative torus shape that may be created.
   Radial Function

In some preferred embodiments, as shown at the left middle of FIG. 21, a radial function setting is provided that enables a user to produce spiral-like shapes. In some illustrative embodiments, one or more of the following variants are offered:
Unity: This setting is for shapes without a radial function.
Archimedian: Selecting either Archimedian or Logarithmic enables one to start designing shells and spiral forms. For Archimedian shells, one additional parameter “a” can be set: r=a.phi.
Logarithmic: For Logarithmic shells, a second parameter “b” is foreseen: r=a exp(b.phi).

In the illustrative embodiment shown in FIG. 21, in order to change the radial function to a user's choice, the user can select a radio button in the Radial Function section of the parameter window. By way of example, FIG. 25 depicts an illustrative radial-function shape that may be created.

Vertical Function

In some preferred embodiments, as shown proximate the lower right side of FIG. 21, there is also functionality provided that enables a user to start creating helical forms (such as, e.g., similar to that of DNA strings). In some illustrative embodiments, either shapes are constructed as normal with a “zero” vertical change or they are made with a “linear” vertical change. For example, in the illustrated embodiment, the user can select either zero or linear using radio buttons as shown. In the linear case, in some embodiments, an additional parameter “a” (z=a.phi) lets a user vary the speed by which the shape alters vertically. By way of example, FIG. 26 depicts an illustrative vertical-function shape that may be created.

Range

In some preferred embodiments, the 3D forms that are created can be truncated into fractions of the entire shapes formed. For example, as shown in FIG. 21, in some embodiments, a “Range” feature can be implemented in which, for example, normal forms can be created with a default longitude ranging from −180° to 180°, while their latitude is given by a default range of between −90° and 90°. In some illustrative embodiments, by adjusting these latitude and/or longitude ranges, fractional forms can be created quite easily. By way of example, FIG. 27 depicts an illustrative fractional-form shape that may be created.

Special Commands

In some preferred embodiments, as further shown in FIG. 21, in addition to the features described above, a number of additional features may be implemented. For example, in some embodiments, from a parameter window as shown in FIG. 21, it is possible to change some or all of the following information:
Resolution: This preferably enables a user to specify how fine-grained the shapes need to be calculated and drawn.
Color: This preferably enables a user to select and/or determine the RGB parameters (such as, e.g., in case the shape is using “constant color” instead of some other color scheme). In some embodiments, a user can select a “constant color” (such as, e.g., via the RMB-menu in the color-ramp sub-menu).
Scale: This preferably enables a user to adjust the size of a shape in a specific direction (by enabling the user to introduce a scale-factor for it).
Random: As shown at the top right of FIG. 21, in some embodiments, a Random feature can be selected. In preferred embodiments, this can operate as described above.
Reset: This preferably is a button that can be pressed in order to have all of the parameters reset to a certain condition, such as, e.g., an initial condition and/or to a certain basic form, such as, e.g., a sphere.
About: This preferably provides a pop-up window that will provide basic information related to, e.g., the program, registration and contact information and the like.
Quit: This preferably provides a means to stop the application.
   2. Additional Illustrative Shape Creator Applications

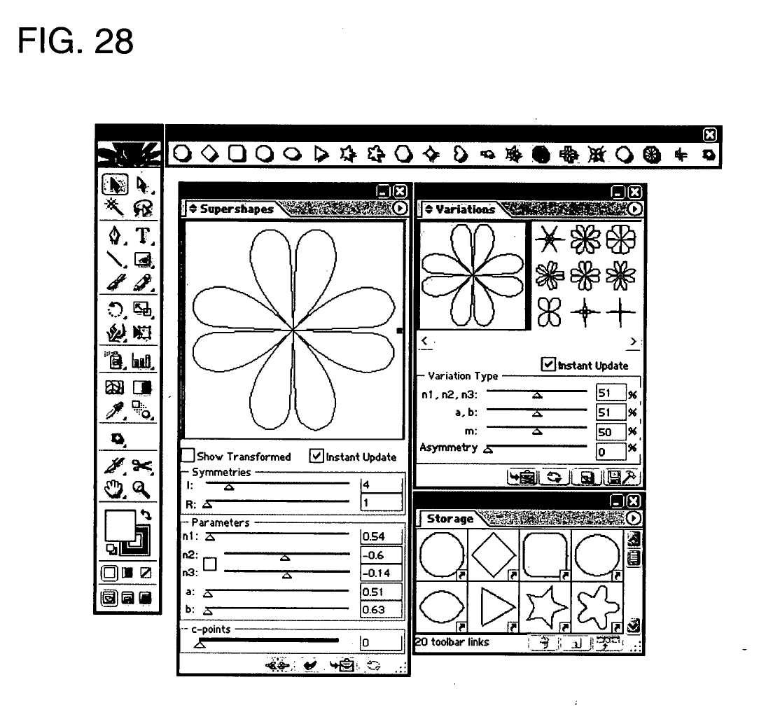

FIGS. 28 to 30 show some additional embodiments of shape creator applications that can be implemented in some other embodiments of the invention. In some illustrative examples, such an application could be advantageously employed as a plug in to another program, such as, e.g., Adobe Illustrator and/or the like.

As shown in FIG. 28, in some illustrative embodiments a shape creator application can be added as an extension or the like to, e.g., Adobe Illustrator. In that regard, as shown, in some preferred embodiments, the Adobe Illustrator toolbar, or the like, contains a new tool in the toolbar: i.e., a tool for the added application (e.g., SUPERGRAPHX™ tool). In addition, as shown the SUPERGRAPHX application adds three new window palettes or tabs: a SUPERSHAPES tab; a SUPERSHAPES Variations tab; and a Storage tab. In FIG. 28, while these three window pallets are shown as displayed concurrently, in some preferred applications, one of these windows would be displayed at a time, with the titled tabs of the remaining two windows being visible as tabs to enable easy toggling between windows in a common GUI mode of operation. In some embodiments, a convenient way of working with the SUPERSHAPES is to have both a SUPERSHAPES palette and a variations palette opened concurrently. In some embodiments, a user can maximize the SUPERSHAPES palette and put it close to the other palette. In that manner, a user can readily create shapes while viewing automatically generated variations on this theme.

The SUPERSHAPES Palette or Tab:

In the illustrative embodiment shown in FIG. 28, a symmetries section is provided that includes the shape parameters: iterations and rotations. These parameters help define the general shape of the figure.
Iterations: gives the number of symmetries in the figure (e.g., the number of blades on a fan or paddles on a windmill).
Rotations: describes the number of times a full circle is made to complete the figure.
   Preferably, these symmetries parameters can be freely changed by moving the sliders or by typing specific values in the text boxes to the right of each slider.

In the illustrative embodiment shown in FIG. 28, a parameters section is also provided that enables users to freely change parameters by moving the sliders or by typing specific values in the text boxes to the right of each slider. As per embodiments above, a user can place a small checkbox between n2 and n3 to allow both parameters to be changed simultaneously. Preferably, all of the parameters can include integers and a fractional part.

In the illustrative embodiment shown in FIG. 28, a C-points section is also preferably provided. The C-point section enables a user to further control their shapes by adding asymmetries and more complexity to the shapes. In some embodiments, when no C-points are used, shapes are purely symmetrical around their centre. In some illustrative embodiments, a user can preferably introduce C-points in a manner to modify the shape such that for each C-point added, the SUPERSHAPE parameters can be changed at locations between C-points (e.g., from between the default triangle shown in FIG. 28 and a newly placed triangle (aka C-point) added thereto. Thus, the SUPERSHAPE parameters can be modified at different positions within the SUPERSHAPE (i.e., based on locations of C-points that may be added).

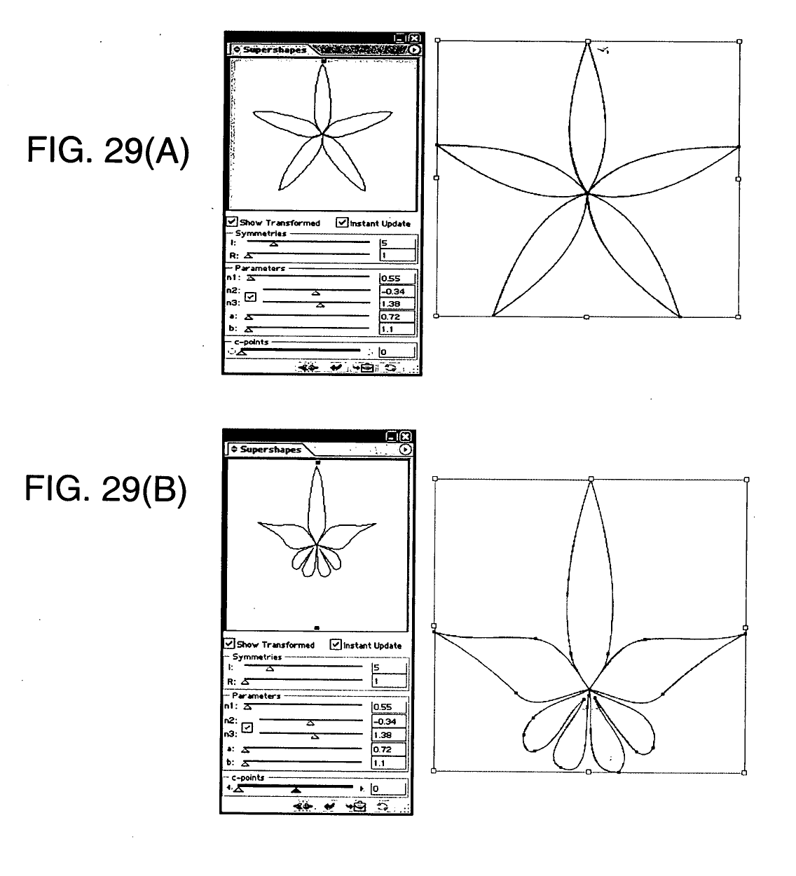

In some illustrative embodiments, the C-points can be added easily. With reference to FIG. 28, by way of example, a user can readily click on the C-point slider and a new triangle C-point will be inserted automatically. In order to alter the parameter values related to a C-point, the C-point can be selected on the C-point slider shown in FIG. 28. For reference, FIG. 29(A) shows an illustrative shape without any C-points added, while FIG. 29(A) shows an illustrative shape with a C-point added at 180 degrees.

When a C-point is selected (NB: one C-point can be selected, such as by clicking on it, such as, e.g., the white one shown in FIG. 29(A)), user can preferably perform the following operations:
Change its parameters (such as, e.g., by moving parameter sliders, etc.).
Change its position (such as, e.g., by dragging the white arrow on the slider or by directly typing the angle value in the associated text box).
Remove the C-point (such as, e.g., by deleting it).

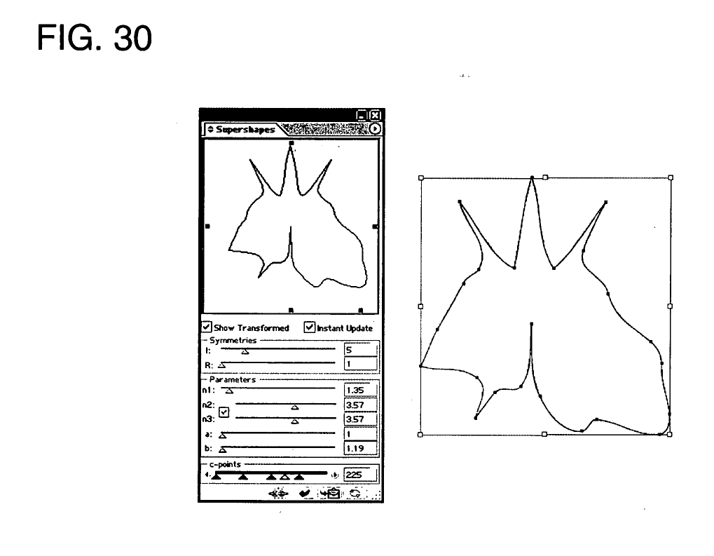

In some preferred embodiments, as shown in FIG. 30, to facilitate usability and appreciation of the region of impact of a C-point, the C-point region of impact can be highlighted in some manner in the shape created, such as shown, e.g., in FIG. 30 by a white region in contrast to the remaining grayed-out portions.

While in this illustrative example, the C-points are used to define regions that will vary by modifying the SUPERFORMULA parameters, it should be understood that in various other embodiments, regions between C-points could be modified in a variety of other ways. In other embodiments, any other local impact could be imparted on the shape in the neighborhood of the C-points.

In the illustrative embodiment shown in FIG. 28, a “show transformed” button is shown. This is an illustrative feature that allows a user to view a SUPERSHAPE in a preview window in normal format (e.g., untransformed) or as shown in a main window (such as, e.g., being scaled, rotated, etc.).

In the illustrative embodiment shown in FIG. 28, an “instant update” checkbox feature is shown. This is an illustrative feature in which a user can check this checkbox such that all changes performed on a SUPERSHAPE would be directly reflected on a main illustrator page, where a shape is presented. On the other hand, if this is unchecked, the changes are kept local in a preview window, allowing the user to create a shape before it affects the user's main page.

In addition, as shown in FIG. 28, the SUPERSHAPES palette or tab includes a plurality of additional buttons (such as, e.g., shown at the bottom of the palette). Preferably, these buttons can include one or more, preferably all, of the following functionality.
Expand: In some preferred embodiments, an “expand” functionality is provided that changes the SUPERSHAPE into another format (such as, e.g., into a format commonly used in a program to which the application may be a plug-in, such as, e.g., suitable for Adobe Illustrator or the like) shape (such as, e.g., consisting of Bezier paths). However, typically, after performing this operation on a SUPERSHAPE, another program (such as, e.g., Adobe Illustrator) will not likely be able to recognize it any longer as a SUPERSHAPE.
Reset: In some preferred embodiments, a “reset” functionality is provided that such that a displayed shape can be reset to a certain value. For example, once a SUPERSHAPE has been selected, it appears in the preview window. When a user manipulates the parameters, the shape keeps on changing. Thus, sometimes, the reset can be used to return back to the parameter values of the shape that was initially selected or to some other default value.
Add to Store: In the preferred embodiments, the user can click on a button in order to save their created shape in a storage area, storage library or the like. See Storage palette or tab discussed below.
Apply Changes: In the preferred embodiments, this feature may be related to the usage of an “Instant Update” checkbox. For example, if a user is working with “Instant Update” unchecked, all the user's changes are kept purely locally in the preview window. If the user desires to view it on the main page, they can then click “Instant Update” to apply the changes and to replace the displayed SUPERSHAPE.
   SUPERSHAPE Variations

In the preferred embodiments, a separate window pallet or tab is provided that relates to the generation of variations on a theme. Preferably, the user can click on the variations tab so as to be presented with a view of the variations window pallet. As shown in the top right corner of FIG. 28, initially the window pallet shows an original selected shape (in a large region in the window pallet) and a first generated set of shape variants (e.g., nine shape variants are shown in the illustrated example).

Upon clicking on one of the nine variants, that variant is then preferably displayed in the large region in the window pallet and a new set of variations are automatically generated in place of the prior nine variants. Preferably, as a user reviews the variations, a history is gradually built which a user can, at any moment, scroll back through and review.

As shown, in some embodiments, as with the SUPERSHAPES pallet, the variations pallet can also include a similar “instant update” checkbox to control the immediate appearance or lack of appearance of the selected shape in the main window.

As shown in FIG. 28, in the variation pallet, the amount of variation of the selected shape is preferably controlled by the setting of the variation type parameters. In some embodiments, for each parameter, the user can set a percentage (such as, e.g., by a slider bar or text box) that defines the extent or chance that this parameter will vary. In some embodiments, an asymmetry in the generated shapes can be introduced by increasing an asymmetry parameter as shown. In some embodiments, the asymmetry parameter will automatically add some C-points as discussed above.

In addition, as shown in FIG. 28, the variations palette or tab includes a plurality of additional buttons (such as, e.g., shown at the bottom of the palette). Preferably, these buttons can include one or more, preferably all, of the following functionality.
Add to Store: This button would have functionality as described above with respect to the SUPERSHAPES tab.
Apply: This button would have functionality similar to that of the “Apply Changes” button in the SUPERSHAPES palette.
Create Instance: In this regard, when a desirable shape has been generated, it can be selected and an instance will be created for the user in the main SUPERSHAPES page.
Save Settings: In this regard, in preferred embodiments, once a user has found an appropriate combination of values for the variation parameters, the user can save these settings for another use session.
   SUPERSHAPE Storage

In the preferred embodiments, a separate window pallet or tab is provided that relates to the SUPERSHAPE storage. Preferably, the user can click on the storage tab so as to be presented with a view of the SUPERSHAPES storage window pallet. As shown in the bottom-right corner of FIG. 28, while creating SUPERSHAPES, either manually or generated them using the variations tab or the like interesting shapes may always be stored by the user for later use. In the preferred embodiments, the storage area provides a library storage or data-region in which these stored shapes can be saved. As should be understood, the shapes could be stored in a database based on parameter values related to these shapes. In view of the small file sizes for many SUPERSHAPES, storage for such SUPERSHAPES should likely have a relatively small impact on data storage resources.

In addition, as shown in FIG. 28, the variations palette or tab includes a plurality of additional buttons (such as, e.g., shown at the bottom of the palette). Preferably, these buttons can include one or more, preferably all, of the following functionality.
Delete: In the preferred embodiments, a button or the like is provided to enable a selected shape to be deleted from the storage area.
Create Instance: In this regard, when desired, a shape in storage can be selected and an instance will be created for the user in the main SUPERSHAPES page.
Show in/Remove From Toolbar: In this regard, in some embodiments, if a particularly desirable or commonly used shape is available in the storage, it can preferably be added to or removed from a set of predefined shapes in a main tool bar, such as, e.g., shown along the very top of FIG. 28.
   Introduction of Outside Shapes (e.g., Analysis):

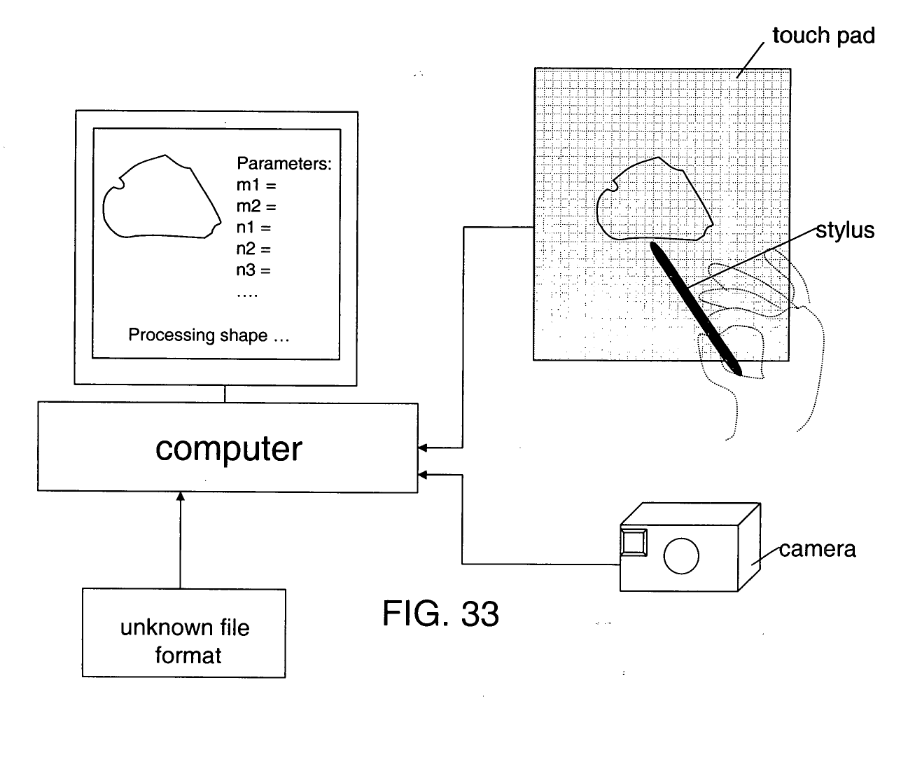

In some alternative embodiments, any of the above-noted graphics processes can include functionality to enable the introduction of shapes from outside sources which are incorporated into the graphics program processing. By way of example, as shown in FIG. 33, in some embodiments, a computer (which can, e.g., simultaneously be running software related to one of the graphics or other applications described herein) can receive digital data from an external source supplying raw image data for processing. This raw image data can then be processed or analyzed so as to identify the raw data based on analysis with the SUPERFORMULA so as to enable the raw image to be 1) combined within the graphics materials (such as, e.g., to combine, mould, blend or otherwise modify the shape with another shape or use another shape to modify the shape) whether or not the image acquired is analyzed and/or 2) analyzed to a) enable categorization of the image acquired, b) manipulation of the image acquired based on techniques described herein, c) space-saving data storage of the acquired image based on SUPERFORMULA principles, d) generation of suggested variations based on principles according to illustrative embodiments described above; and/or e) the like.

In the illustrative example shown in FIG. 33, the raw image data acquired can include one or more image: 1) drawn by hand (shown in dashed lines) using a stylus on an electronic touch pad which transmits coordinate data of the path traversed by the stylus to the computer (i.e., such coordinate information represented schematically by the dashed graph-lines on the touch pad); 2) obtained via a camera, such as, e.g., a digital camera, and transmitted in digital form to the computer for analysis; 3) acquired via another means that is in an unknown file format.

In some embodiments, the analysis of the image can employ principals as described in the above-referenced priority patent applications, which are incorporated herein by reference. In addition, in various embodiments, analysis can involve some or all of the following.

Shape Analysis with Inside-Outside Functions in 2D and/or 3D:

In the following sections, additional discussion related to shape analysis is provided, followed by a discussion on signal analysis. These discussions are for illustrative purposes. In reality, the distinction between these two forms is rather artificial. In shape analysis, two generally opposite solutions are discussed, one using error-of-fit functions and one using a generalized Fourier series. In addition to shape and signal analysis, analysis can be useful in a variety of other contexts, as discussed in the prior applications incorporated herein by reference, such as, e.g., for data compression and the like.

In some embodiments, in order to render an estimate, a SUPERFORMULA representation can be done, in a similar way it has been done, e.g., for extended superellipses and superquadrics (using Bezier functions in the exponent of a superellipse formula. See, e.g., Zhou, L., Kambhamettu, C., 2000. Extending Superquadrics with Exponent Functions: Modelling and Reconstruction, Graphical Models doi:10.1006/gmod.2000.0529, the entire disclosure of which is incorporated herein by reference. Using the SUPERFORMULA, also in c-point formulations, as an inside/outside function, minimization algorithms (using, e.g., simulated annealing) can be used minimizing error-of-fit. In addition, superellipse and SUPERSHAPE fitting will also be useful for video compression.

In some illustrative applications, an application for creating SUPERSHAPES (such as, e.g., a plug-in like the present assignee's SUPERGRAPHX for Adobe Illustrator) can create and modify SUPERSHAPES which can then be converted into the native format of the another application (such as, e.g., in the case of Adobe Illustrator a format based on Beziers). In some instances, such as, e.g., depicted schematically in FIG. 33, shapes made in another application, such as, e.g., Adobe Illustrator, may be translated into SUPERSHAPES by way of analyses described herein.

In some embodiments, a designer can make a sketch or an outline (such as, e.g., using a touchpad as shown in FIG. 33) that can be input into the application, such as, e.g., the present assignee's SUPERGRAPHX application which will analyze the image, display the image in the preview window, and then fully treat the image like a SUPERSHAPE, with, inter alia, the possibility of locally changing segments, generating variations directly, storing the shapes and the like. Notably, this can also be done in 3D, fitting superquadrics to a variety of shapes. See, e.g., the following publications, the entire disclosures of each of which are all incorporated herein by reference.
Yan Zhang Experimental comparison of superquadric fitting objective function. Pattern Recognition Letters Volume 24, Issue 14 (October 2003).
Y. Zhang, J. Paik, A. Koschan, M. A. Abidi, 3-D Object Representation from Multi-View Range Data Applying Deformable Superquadrics, Proceedings of the 16 th International Conference on Pattern Recognition (ICPR102) Volume 3, p. 30611, Aug. 11-15, 2002.
A. Jaklic, A. Leonardis, Franc Solina, Segmentation and recovery of superquadrics: computational imaging and vision, Kluwer Academic Publishers, Norwell, Mass., 2000.
   In addition, it is possible to analyze given 3D composite shapes in their CSG components and structure, such that given a 3D object this would enable the full reconstruction of the CSG and the parts assembly structure.
   Shape Analysis using a Generalized Fourier Series

With a generalized Fourier series, instead of base functions circle, cosine and sine, any SUPERSHAPE (and associated trigonometric functions) can be used as base functions (see e.g. the above-identified prior patent applications incorporated herein by reference and also, e.g., page 165 of Inventing the Circle, Johan Gielis, published by Geniaal bvba, Nottebohmstraat 8, B-2018 Antwerpen, 2003). For example, this enables, for example, one to describe a square as a square, and not as an infinite series, but as only one single shape. In fact, a theorem by B. Chen states that the only shapes which can be represented in a finite Fourier series is a circle and a line. All other shapes need an infinite series. Finite series are approximations only. The Fourier series approximation is performed in a Euclidean space with Euclidean metric L₂ (supercircle with n=2 is a circle). However, essentially all SUPERSHAPES can be described in a finite generalized Fourier series when the appropriate base functions are used. This may be trivial, since if the base function is the shape itself, the shape is already encoded in one term. In some embodiments, developing a reverse procedure requires the use of the whole SUPERFORMULA space, searching for a starting shape which could serve as a base function. But in fact, this problem is already solved using the approaches described herein-above which will allow a direct calculation of the base shape and base function. This drastically reduces the length of Fourier series, until it converges to precisely one term, the shape itself. This then provides a very compact representation. In fact so compact, that it would not even have an appreciable need for any compression.

Compression using vectors is also possible in other ways. For example, an image may be decomposed in zones having similar color. These zones can then be described by a SUPERFORMULA very compactly (such as, e.g., in Flash, Beziers curves are used today). But since it is an implicit function, unlike in Flash or similar vector compression algorithms with well-distinguishable zones of different color and intensity, the gradient between the zones described by the SUPERFORMULA can be encoded directly as a gradient (e.g., height maps and colors above). The same procedure can be used in a generalized cosine transform. When the cosine transform DCT is adapted to zones, not only blocks, compression algorithms have been developed, with compression factors superior to those of wavelets. These blocks can also be approximated as SUPERFORMULA objects.

Signal Analysis and Other Analyses

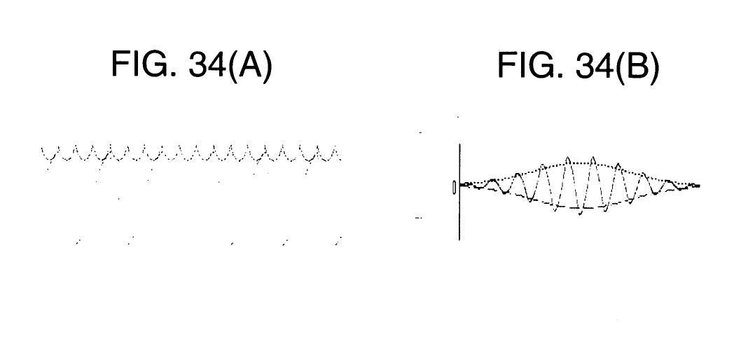

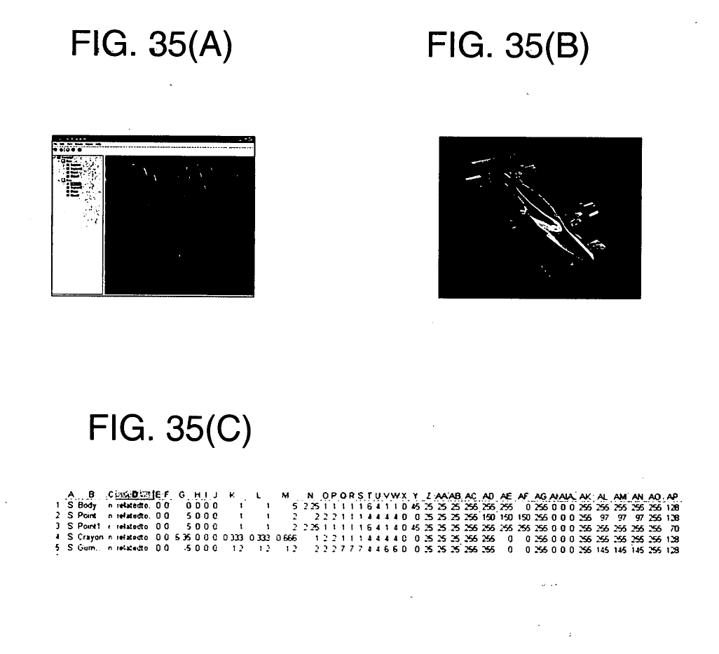

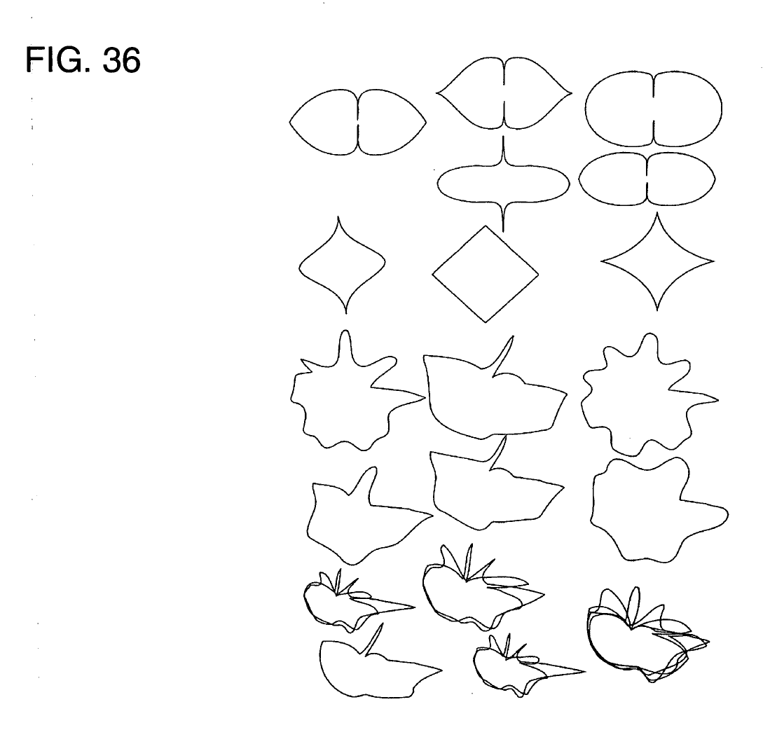

In various other applications, approaches according to embodiments described herein can be used to analyze data and/or for compression. In this regard, FIG. 34(A) depicts both a distance function (upper) and supertrigonometric function (based on a triangle) shown (i.e., using the same formula, but with a different graphical expression). On the other hand, FIG. 34(B) shows a windowed trigonometric function, which is also fully encoded in only the SUPERFORMULA. Among other things, this technique can be applied directly to wavelets, with the SUPERFORMULA providing the compact support for the wavelets.

Broad Scope of the Invention:

While illustrative embodiments of the invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

1. A method for the creation of computer graphics images, comprising:
a) generating at least one shape with a computer based on a parameterized formula;
b) having said computer suggest a plurality of variations of said at least one shape.

2. The method of claim 1, wherein said at least one shape is a two-dimensional shape.

3. The method of claim 1, wherein said at least one shape is a three-dimensional shape.

4. The method of claim 1, wherein said parameterized formula is a representation of the superformula formula.

5. The method of claim 1, further including having said computer suggest a plurality of variations based on variations to at least some of the parameters in said parameterized formula.

6. The method of claim 1, wherein said formula includes parameters for symmetry and exponent parameters for shape.

7. The method of claim 1, wherein said formula includes parameters for symmetry, shape and size.

8. The method of claim 7, wherein said parameters for symmetry include rotational symmetry (m) and said parameters for shape include exponents (n).

9. The method of claim 1, further including having said computer suggest a plurality of variations that are displayed concurrently, having a user select at least one of said plurality of variations, and having said computer suggest a plurality of new variations based on said selected at least one of said plurality of variations.

10. The method of claim 1, further including storing images selected for storage and displaying said images as part of a library of stored shapes.

11. The method of claim 1, further including storing images selected for storage in a database by storing said parameters and displaying said images based on a module that creates an image by introducing said parameters into said formula.

12. The method of claim 1, further including having said computer suggest at least one image based on a random selection of parameters for said formula.

13. The method of claim 1, further including having a user select metrics by which the computer suggests said variations.

14. The method of claim 13, wherein said metrics include an amount of variation.

15. A method of generating a three dimensional image, comprising:
a) generating a first two-dimensional shape with a computer based on a parameterized formula;
b) displaying said first shape on a display
c) generating a second two-dimensional shape with a computer based on a parameterized formula;
d) displaying said second shape on a display proximate said first shape;
e) creating a three-dimensional shape based on a combination of said first shape and said second shape; and
f) displaying said three-dimensional shape proximate said first and second two-dimensional shapes.

16. The method of claim 15, wherein said parameterized formula is a representation of the superformula formula.

17. The method of claim 15, further including having said computer suggest a plurality of variations based on variations to at least some of the parameters in said parameterized formula.

18. The method of claim 15, wherein said formula includes parameters for symmetry and exponent parameters for shape.

19. The method of claim 15, wherein said formula includes parameters for symmetry, shape and size.

20. The method of claim 19, wherein said parameters for symmetry include rotational symmetry (m) and said parameters for shape include exponents (n).

21. A method for the creation of computer graphics images, comprising: generating at least one shape with a computer based on a representation of the superformula formula, in which said representation includes at least four parameters Including at least one symmetry parameter and at least one exponent parameter, and in which at least one of said parameters is a function for at least a portion of the generated shape.

22. The method of claim 21, further including a graphical user interface having a cross-point feature for modifying the generated shape.

23. A method for the creation of computer graphics image data, comprising: generating at least one shape with a computer based on a representation of the superformula formula, in which said representation includes at least four parameters including at least one symmetry parameter and at least one exponent parameter, and storing said generated image In a common file format.

24. The method of claim 23, wherein said common file format supports at least .DXF, .OBJ, or .TGA formats.

25. A method for generating a combined shape, comprising:
a) generating a first two-or-three dimensional shape with a computer based on a parameterized formula;
b) displaying said first shape on a display
c) displaying a second two-or-three dimensional shape with said computer on said display proximate said first shape;
d) moving said first and/or second shapes relative to one another such that they are placed in a desired overlapping relationship;
e) while in said overlapping relationship, combining said first and second shapes together to create a combined new shape.

26. The method of claim 25, wherein said combining includes forming a union of said shapes.

27. The method of claim 25, wherein said combining includes substracting one of said shapes from the other.

28. The method of claim 25, wherein said parameterized formula is a representation of the superformula formula with at least four parameters, including symmetry and exponent parameters.

28. The method of claim 25, wherein said second shape is input into said computer as raw image data from an external source.

29. The method of claim 28, wherein said external source includes an electronic writing instrument for a user to manually create said second shape.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (Cancelled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)
